(19) United States
(12) Patent Application Publication
(10) Pub. No.: US 2025/0291930 A1
(43) Pub. Date: Sep. 18, 2025

(54) SYSTEMS AND METHOD FOR GENERATING RISK SCORES

(71) Applicant: KnowBe4, Inc., Clearwater, FL (US)

(72) Inventors: Mark William Patton, Belleair, FL (US); Sunil Mathew Thomas, Palm Harbor, FL (US); Paras Nigam, Bangalore (IN); Atish Kathpal, Bangalore (IN); Abraham Brody, Thousand Oaks, CA (US); Shilendra Soman, Kerala (IN); Philippe R. Broccard, Clear Water, FL (US); Jeffrey Alan Gelinas, JR., St. Petersburg, FL (US)

(73) Assignee: KnowBe4, Inc., Clearwater, FL (US)

(21) Appl. No.: 18/606,669

(22) Filed: Mar. 15, 2024

(51) Int. Cl. G06F 21/57

(52) U.S. Cl. CPC G06F 21/577

(57) ABSTRACT

Systems and methods are described for generating a risk score of a user based at least on groups of events related to security. In an example, a method is described that includes receiving data associated with a plurality of events, identifying a plurality of buckets, assigning each event to a bucket based at least on a type associated with the event, and computing a risk score for a user based at least on a function of the weight assigned to each bucket and a quantity of events in each bucket. In some examples, systems and methods also include providing a graphical user interface to display the risk score.

### FIELD OF THE DISCLOSURE

This disclosure generally relates to systems and methods associated with measuring security risk.

### BACKGROUND OF THE DISCLOSURE

It can be useful to perform simulated phishing attacks on an individual or set of individuals for the purposes of extracting information from a device used by the individuals. A phishing attack involves an attempt to acquire sensitive information such as usernames, passwords, credit card details, etc., often for malicious reasons, possible by masquerading as a trustworthy entity. For example, an email may be sent to a device controlled by an individual (a target), the email having an attachment that causes the device to perform malicious actions when executed or a link to a webpage that either causes the device to perform malicious actions when accessed or prompts the user to execute a malicious program. Malicious actions may include malicious data collection or actions harmful to the normal functioning of a device on which the email was activated, or any other malicious actions capable of being performed by a program or a set of programs.

### BRIEF SUMMARY OF THE DISCLOSURE

Systems and methods are provided for generating risk scores. In some embodiments, the systems and methods involve techniques for generating risk scores of users based on groups of events related to security.

In an example embodiment, a method is described that includes receiving data associated with a plurality of events over time, the plurality of events representing one or more security risks associated with one or more users to an organization. In some embodiments, the method includes identifying a plurality of buckets for which to assign the plurality of events Each bucket identifies a collection of events that are assigned a level of risk from a plurality of levels of risk, each level of risk assigned a weight. In some embodiments, the method includes assigning each event of the plurality of events to a bucket of the plurality of buckets. The bucket is assigned based at least on a type associated with each event. In some embodiments, the method includes computing a risk score for a user of the one or more users. The risk score is computed based at least on a function of the weight assigned to each bucket and a quantity of events in each bucket. In some embodiments, the method includes providing a graphical user interface configured to display the risk score and information identifying reasons computation of the risk score changes over time for the user.

In some embodiments, the graphical user interface is further configured to display one or more recommendations for mitigations based on risk factors identified while generating the risk score.

In some embodiments, the method further includes determining an action to take based at least on the risk score.

In some embodiments, the method further includes taking the action of providing electronic training to the user corresponding to the risk score of the user or the action of initiating a simulated phishing campaign targeted to the user based at least on the risk score.

In some embodiments, each event comprises a type of a risky event, a secure event or a mitigation event.

In some embodiments, the method further includes assigning each of the plurality of buckets to an aggregator bucket of a plurality of aggregator buckets.

In some embodiments, each aggregator bucket of the plurality of aggregator buckets includes a collection of one or more buckets representing related elements of security risk.

In some embodiments, each aggregator bucket of the plurality of aggregator buckets is assigned second weight according to a second level of risk assigned to each aggregator bucket.

In some embodiments, the method further includes generating the risk score for the user based on the function of the second weight assigned to each aggregator bucket.

In some embodiments, the method further includes removing an event of the plurality events from a bucket based on meeting a threshold of a number of look back days.

In some embodiments, the method further includes modifying the risk score based at least on one of a booster factor or an offset of the user or the organization.

In another example embodiment, a system is described that includes one or more servers comprising one or more processors, coupled to memory and configured to receive a plurality of events over time. The plurality of events is related to security risk of one or more users to an organization. In some embodiments, the one or more servers are configured to identify a plurality of buckets for which to assign the plurality of events. Each bucket identifies a collection of events that are assigned a level of risk from a plurality of levels of risk, each level of risk assigned a weight. In some embodiments, the one or more servers are configured to assign each event of the plurality of events into a bucket of the plurality of buckets. The one or more servers assign each event into a bucket based at least on a type of each event. In some embodiments, the one or more servers are configured to compute a risk score (e.g., an explainable and deterministic score representing cybersecurity risk over a period of time, the cybersecurity risk) for a user of the one or more users. The risk score is computed based at least on a function of the weight assigned to each bucket and a quantity of events in each bucket. In some embodiments, the one or more servers are configured to cause a display of a graphical user interface configured to display the risk score and information identifying reasons computation of the risk score changes over time for the user. In some embodiments, a model is involved in one or more of the identification of the plurality of buckets, assignment of each event into a bucket, and computation of the risk score.

But while simulated phishing attacks can be useful in identifying devices (and corresponding inputs provided by individuals or groups of individuals) that are susceptible to phishing attacks, it can be difficult to determine to what degree a given device or group of devices is susceptible to future phishing attacks when analyzed in isolation. By virtue of the implementation of the systems, methods, and underlying techniques disclosed herein, risk evaluation can be automated and performed over periods of time across a wide array of users, thereby providing more accurate and consistent analysis of such risk as well as targeted mitigation of such risk. For example, as opposed to certain simulated phishing attacks that test devices individually and at certain, isolated points in time, the present disclosure provides for the automated simulation of phishing attacks and capture of information related to the corresponding response of the target. This can occur over a period of time (e.g., hours, days, weeks, etc.). Based on this additional information, the disclosed systems can then determined which devices are more susceptible to a phishing attacks or similar attacks over time, and cause one or more actions to be performed as described herein.

By carefully determining which users or groups of users and associated devices or groups of devices are susceptible to attacks and performing one or more actions based on these determinations, a system can identify vulnerable users and associated devices and proactively address the vulnerabilities while forgoing action with respect to users and associated devices that are less vulnerable. This, in turn, can reduce the amount of computing resources dedicated to constantly monitoring multiple users and associated devices (e.g., resources that would otherwise be dedicated to monitoring the network traffic of tens, thousands, or even millions of devices), and focus such monitoring on devices that are more likely to be involved (or remain involved) in risky behaviors. Additionally, network communications can be reduced, thereby reducing the amount of data transmitted between devices that would otherwise be expended on broad, unfocused efforts to generate train employees in a virtual setting.

By virtue of the implementation of the techniques described herein, events (e.g., raw events) representing behavior of users can be used to determine activities involving users and corresponding devices that are risky or not risky. By grouping events or aspects thereof into buckets and aggregator buckets, the susceptibility of users or groups of users and corresponding devices to cybersecurity threat vectors can be quickly identified. These threat vectors may be associated with, for example, web security, endpoint security, and/or the like and the corresponding susceptibilities can be quickly correlated with remediation actions (which can be described when reporting risk scores). Each of the buckets and aggregator buckets described herein may correspond to one or more susceptibilities that can be identified as associated with cybersecurity best practices. And the association (e.g., design) of the buckets with various susceptibilities can enable scalable updates to the buckets. These updates can be made in response to evolution in the landscape of cybersecurity threat vectors. The grouping of events into buckets and aggregator buckets to assign relative weights can enable the appropriate control the contribution of each event to the overall risk score of a user, providing determinism and complete transparency to risk score computations described herein.

Other aspects and advantages of the disclosure will become apparent from the following detailed description, taken in conjunction with the accompanying drawings, which illustrate, by way of example, the principles of the disclosure.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising client device in communication with server device, according to some embodiments;

FIG. 1B is a block diagram depicting a cloud computing environment comprising client device in communication with cloud service providers, according to some embodiments;

FIGS. 1C and 1D are block diagrams depicting embodiments of computing devices useful in connection with the methods and systems described herein, according to some embodiments;

FIG. 2A depicts an implementation of some of the architecture of an implementation of a system capable of performing artificial intelligence driven simulated phishing attack campaigns as part of a security awareness system, according to some embodiments;

FIG. 2B depicts an implementation of an artificial intelligence driven agent (AIDA) system, according to some embodiments;

FIG. 3 depicts an implementation of some of the architecture of an implementation of a system capable of creating artificial intelligence models for use as part of a security awareness system, according to some embodiments;

FIG. 4 depicts an implementation of depicts an example of data exchange and analysis by systems capable of generating risk scores, according to some embodiments;

FIG. 5 depicts a flowchart of a process for generating risk scores, according to some embodiments; and

FIG. 6 depicts an example set of risk scores, according to some embodiments.

### DETAILED DESCRIPTION

For purposes of reading the description of the various embodiments below, the following descriptions of the sections of the specifications and their respective contents may be helpful:

Section A describes a network environment and computing environment which may be useful for practicing embodiments described herein.

Section B describes an artificial intelligence network and environment which may be useful for practicing embodiments described herein.

Section C describes systems and techniques capable of generating risk scores.

### A. Computing and Network Environment

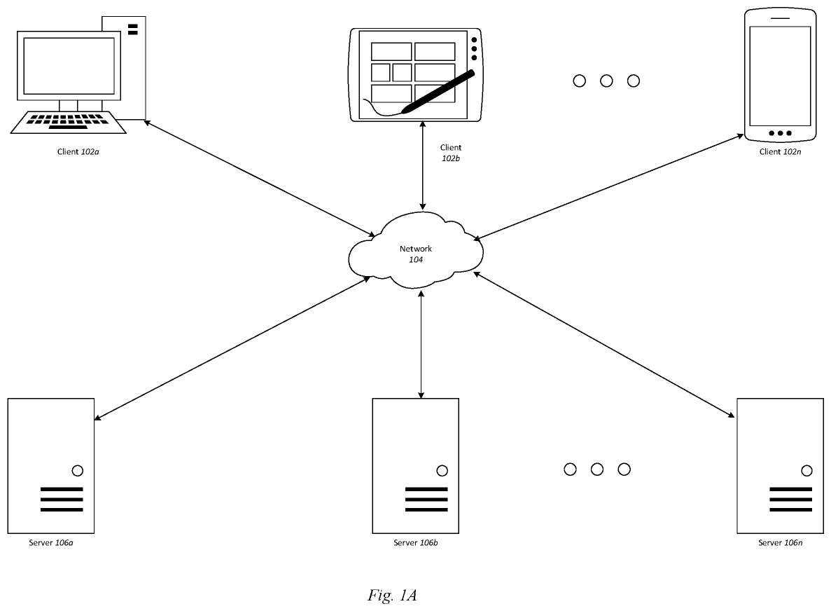

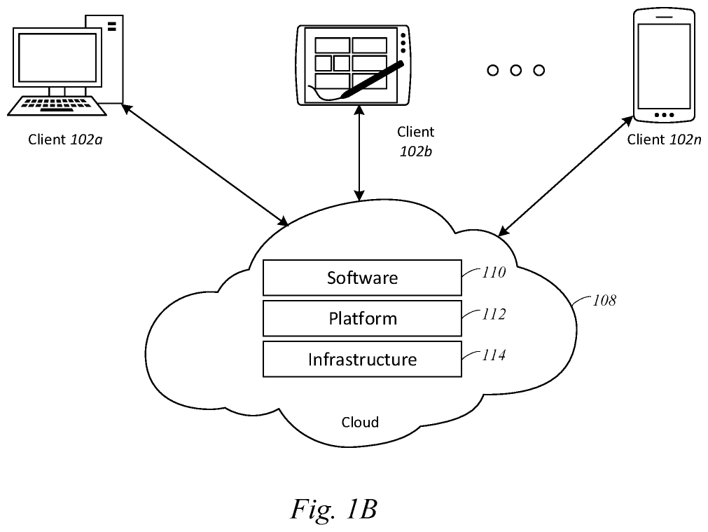

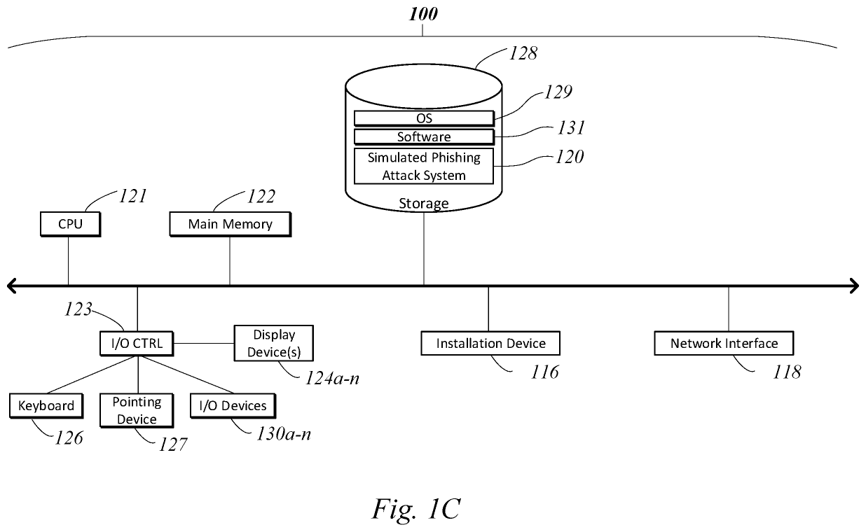

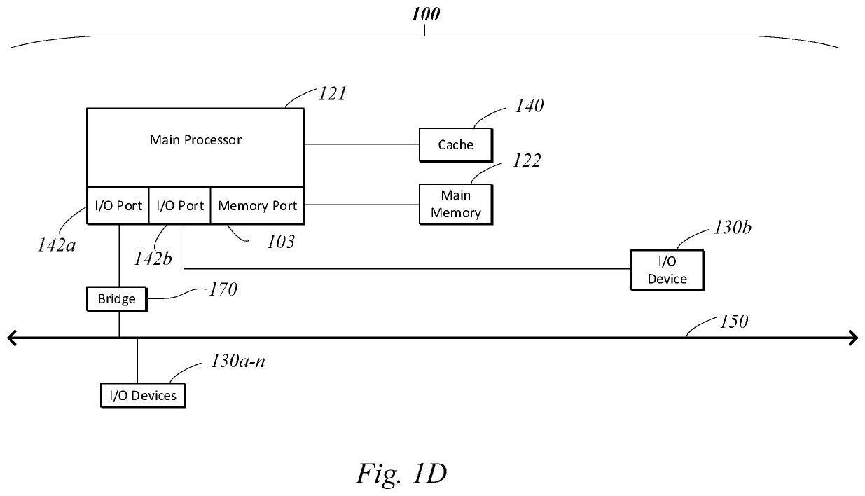

Prior to discussing specific embodiments of the present solution, it may be helpful to describe aspects of the operating environment as well as associated system components (e.g. hardware elements) in connection with the methods and systems described herein. Referring to FIG. 1A, an embodiment of a network environment is depicted. In brief overview, the network environment includes one or more clients 102a-102n (also generally referred to as local machines(s) 102, client(s) 102, client node(s) 102, client machine(s) 102, client computer(s) 102, client device(s) 102, endpoint(s) 102, or endpoint node(s) 102) in communication with one or more servers 106a-106n (also generally referred to as server(s) 106, node(s) 106, machine(s) 106, or remote machine(s) 106) via one or more networks 104. In some embodiments, a client 102 has the capacity to function as both a client node seeking access to resources provided by a server and as a server providing access to hosted resources for other clients 102a-102n.

Although FIG. 1A shows a network 104 between the clients 102 and the servers 106, the clients 102 and the servers 106 may be on the same network 104. In some embodiments, there are multiple networks 104 between the clients 102 and the servers 106. In one of these embodiments, a network 104′ (not shown) may be a private network and a network 104 may be a public network. In another of these embodiments, a network 104 may be a private network and a network 104′ may be a public network. In still another of these embodiments, networks 104 and 104′ may both be private networks.

The network 104 may be connected via wired or wireless links. Wired links may include Digital Subscriber Line (DSL), coaxial cable lines, or optical fiber lines. Wireless links may include Bluetooth®, Bluetooth Low Energy (BLE), ANT/ANT+, ZigBee, Z-Wave, Thread, Wi-Fi®, Worldwide Interoperability for Microwave Access (WiMAX®), mobile WiMAX®, WiMAX®-Advanced, NFC, SigFox, LoRa, Random Phase Multiple Access (RPMA), Weightless-N/P/W, an infrared channel or a satellite band. The wireless links may also include any cellular network standards to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommuniations-2000 (IMT-2000) specification, and the 4G standards may correspond to the International Mobile Telecommunication Advanced (IMT-Advanced) specification. Examples of cellular network standards include AMPS, GSM, GPRS, UMTS, CDMA2000, CDMA-1×RTT, CDMA-EVDO, LTE, LTE-Advanced, LTE-M1, and Narrowband IoT (NB-IoT). Wireless standards may use various channel access methods, e.g. FDMA, TDMA, CDMA, or SDMA. In some embodiments, different types of data may be transmitted via different links and standards. In other embodiments, the same types of data may be transmitted via different links and standards.

The network 104 may be any type and/or form of network. The geographical scope of the network may vary widely and the network 104 can be a body area network (BAN), a personal area network (PAN), a local-area network (LAN), e.g. Intranet, a metropolitan area network (MAN), a wide area network (WAN), or the Internet. The topology of the network 104 may be of any form and may include, e.g., any of the following: point-to-point, bus, star, ring, mesh, or tree. The network 104 may be an overlay network which is virtual and sits on top of one or more layers of other networks 104′. The network 104 may be of any such network topology as known to those ordinarily skilled in the art capable of supporting the operations described herein. The network 104 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv4 and IPV6), or the link layer. The network 104 may be a type of broadcast network, a telecommunications network, a data communication network, or a computer network.

In some embodiments, the system may include multiple, logically-grouped servers 106. In one of these embodiments, the logical group of servers may be referred to as a server farm or a machine farm. In another of these embodiments, the servers 106 may be geographically dispersed. In other embodiments, a machine farm may be administered as a single entity. In still other embodiments, the machine farm includes a plurality of machine farms. The servers 106 within each machine farm can be heterogeneous-one or more of the servers 106 or machines 106 can operate according to one type of operating system platform (e.g., Windows, manufactured by Microsoft Corp. of Redmond, Washington), while one or more of the other servers 106 can operate according to another type of operating system platform (e.g., Unix, Linux, or Mac OSX).

In one embodiment, servers 106 in the machine farm may be stored in high-density rack systems, along with associated storage systems, and located in an enterprise data center. In this embodiment, consolidating the servers 106 in this way may improve system manageability, data security, the physical security of the system, and system performance by locating servers 106 and high-performance storage systems on localized high-performance networks. Centralizing the servers 106 and storage systems and coupling them with advanced system management tools allows more efficient use of server resources.

The servers 106 of each machine farm do not need to be physically proximate to another server 106 in the same machine farm. Thus, the group of servers 106 logically grouped as a machine farm may be interconnected using a wide-area network (WAN) connection or a metropolitan-area network (MAN) connection. For example, a machine farm 38 may include servers 106 physically located in different continents or different regions of a continent, country, state, city, campus, or room. Data transmission speeds between servers 106 in the machine farm can be increased if the servers 106 are connected using a local-area network (LAN) connection or some form of direct connection. Additionally, a heterogeneous machine farm may include one or more servers 106 operating according to a type of operating system, while one or more other servers execute one or more types of hypervisors rather than operating systems. In these embodiments, hypervisors may be used to emulate virtual hardware, partition physical hardware, virtualize physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alta, California; the Xen hypervisor, an open source product whose development is overseen by Citrix Systems, Inc. of Fort Lauderdale, Florida; the HYPER-V hypervisors provided by Microsoft, or others. Hosted hypervisors may run within an operating system on a second software level. Examples of hosted hypervisors may include VMWare Workstation and VirtualBox, manufactured by Oracle Corporation of Redwood City, California.

Management of the machine farm may be de-centralized. For example, one or more servers 106 may comprise components, subsystems and modules to support one or more management services for the machine farm. In one of these embodiments, one or more servers 106 provide functionality for management of dynamic data, including techniques for handling failover, data replication, and increasing the robustness of the machine farm. Each server 106 may communicate with a persistent store and, in some embodiments, with a dynamic store.

Server 106 may be a file server, application server, web server, proxy server, appliance, network appliance, gateway, gateway server, virtualization server, deployment server, SSL VPN server, or firewall. In one embodiment, a plurality of servers 106 may be in the path between any two communicating servers 106.

Referring to FIG. 1B, a cloud computing environment is depicted. A cloud computing environment may provide client 102 with one or more resources provided by a network environment. The cloud computing environment may include one or more clients 102a-102n, in communication with the cloud 108 over one or more networks 104. Clients 102 may include, e.g., thick clients, thin clients, and zero clients. A thick client may provide at least some functionality even when disconnected from the cloud 108 or servers 106. A thin client or zero client may depend on the connection to the cloud 108 or server 106 to provide functionality. A zero client may depend on the cloud 108 or other networks 104 or servers 106 to retrieve operating system data for the client device 102. The cloud 108 may include back end platforms, e.g., servers 106, storage, server farms or data centers.

The cloud 108 may be public, private, or hybrid. Public clouds may include public servers 106 that are maintained by third parties to the clients 102 or the owners of the clients. The servers 106 may be located off-site in remote geographical locations as disclosed above or otherwise. Public clouds may be connected to the servers 106 over a public network. Private clouds may include private servers 106 that are physically maintained by clients 102 or owners of clients. Private clouds may be connected to the servers 106 over a private network 104. Hybrid clouds 109 may include both the private and public networks 104 and servers 106.

The cloud 108 may also include a cloud-based delivery, e.g. Software as a Service (SaaS) 110, Platform as a Service (PaaS) 112, and Infrastructure as a Service (IaaS) 114. IaaS may refer to a user renting the user of infrastructure resources that are needed during a specified time period. IaaS provides may offer storage, networking, servers or virtualization resources from large pools, allowing the users to quickly scale up by accessing more resources as needed. Examples of IaaS include Amazon Web Services (AWS) provided by Amazon, Inc. of Seattle, Washington, Rackspace Cloud provided by Rackspace Inc. of San Antonio, Texas, Google Compute Engine provided by Google Inc. of Mountain View, California, or RightScale provided by RightScale, Inc. of Santa Barbara, California. PaaS providers may offer functionality provided by IaaS, including, e.g., storage, networking, servers or virtualization, as well as additional resources, e.g., the operating system, middleware, or runtime resources. Examples of PaaS include Windows Azure provided by Microsoft Corporation of Redmond, Washington, Google App Engine provided by Google Inc., and Heroku provided by Heroku, Inc. of San Francisco California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include Google Apps provided by Google Inc., Salesforce provided by Salesforce.com Inc. of San Francisco, California, or Office365 provided by Microsoft Corporation. Examples of SaaS may also include storage providers, e.g. Dropbox provided by Dropbox Inc. of San Francisco, California, Microsoft OneDrive provided by Microsoft Corporation, Google Drive provided by Google Inc., or Apple iCloud provided by Apple Inc. of Cupertino, California.

Clients 102 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 102 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 102 may access SaaS resources through the use of web-based user interfaces, provided by a web browser (e.g. Google Chrome, Microsoft Internet Explorer, or Mozilla Firefox provided by Mozilla Foundation of Mountain View, California). Clients 102 may also access SaaS resources through smartphone or tablet applications, including e.g., Salesforce Sales Cloud, or Google Drive App. Clients 102 may also access SaaS resources through the client operating system, including e.g. Windows file system for Dropbox.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

The client 102 and server 106 may be deployed as and/or executed on any type and form of computing device, e.g., a computer, network device or appliance capable of communicating on any type and form of network and performing the operations described herein.

FIGS. 1C and 1D depict block diagrams of a computing device 100 useful for practicing an embodiment of the client 102 or a server 106. As shown in FIGS. 1C and 1D, each computing device 100 includes a central processing unit 121, and a main memory unit 122. As shown in FIG. 1C, a computing device 100 may include a storage device 128, an installation device 116, a network interface 118, and I/O controller 123, display devices 124a-124n, a keyboard 126 and a pointing device 127, e.g., a mouse. The storage device 128 may include, without limitation, an operating system, software, and a software of a simulated phishing attack system 120. As shown in FIG. 1D, each computing device 100 may also include additional optional elements, e.g., a memory port 103, a bridge 170, one or more input/output devices 130a-130n (generally referred to using reference numeral 130), and a cache memory 140 in communication with the central processing unit 121.

The central processing unit 121 is any logic circuitry that responds to and processes instructions fetched from the main memory unit 122. In many embodiments, the central processing unit 121 is provided by a microprocessor unit, e.g.: those manufactured by Intel Corporation of Mountain View, California; those manufactured by Motorola Corporation of Schaumburg, Illinois; the ARM processor and TEGRA system on a chip (SoC) manufactured by Nvidia of Santa Clara, California; the POWER7 processor, those manufactured by International Business Machines of White Plains, New York; or those manufactured by Advanced Micro Devices of Sunnyvale, California. The computing device 100 may be based on any of these processors, or any other processor capable of operating as described herein. The central processing unit 121 may utilize instruction level parallelism, thread level parallelism, different levels of cache, and multi-core processors. A multi-core processor may include two or more processing units on a single computing component. Examples of multi-core processors include the AMD PHENOM IIX2, INTER CORE i5 and INTEL CORE i7.

Main memory unit 122 may include on or more memory chips capable of storing data and allowing any storage location to be directly accessed by the microprocessor 121. Main memory unit 122 may be volatile and faster than storage 128 memory. Main memory units 122 may be Dynamic Random-Access Memory (DRAM) or any variants, including static Random-Access Memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 122 or the storage 128 may be non-volatile; e.g., non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. The main memory 122 may be based on any of the above described memory chips, or any other available memory chips capable of operating as described herein. In the embodiment shown in FIG. 1C, the processor 121 communicates with main memory 122 via a system bus 150 (described in more detail below). FIG. 1D depicts an embodiment of a computing device 100 in which the processor communicates directly with main memory 122 via a memory port 103. For example, in FIG. 1D the main memory 122 may be DRDRAM.

FIG. 1D depicts and embodiment in which the main processor 121 communicates directly with cache memory 140 via a secondary bus, sometimes referred to as a backside bus. In other embodiments, the main processor 121 communicates with cache memory 140 using the system bus 150. Cache memory 140 typically has a faster response time than main memory 122 and is typically provided by SRAM, BSRAM, or EDRAM. In the embodiment shown in FIG. 1D, the processor 121 communicates with various I/O devices 130 via a local system bus 150. Various buses may be used to connect the central processing unit 121 to any of the I/O devices 130, including a PCI bus, a PCI-X bus, or a PCI-Express bus, or a NuBus. For embodiments in which the I/O device is a video display 124, the processor 121 may use an Advanced Graphic Port (AGP) to communicate with the display 124 or the I/O controller 123 for the display 124. FIG. 1D depicts and embodiment of a computer 100 in which the main processor 121 communicates directly with I/O device 130b or other processors 121′ via HYPERTRANSPORT, RAPIDIO, or INFINIBAND communications technology. FIG. 1D also depicts an embodiment in which local busses and direct communication are mixed: the processor 121 communicates with I/O device 130a using a local interconnect bus while communicating with I/O device 130b directly.

A wide variety of I/O devices 130a-130n may be present in the computing device 100. Input devices may include keyboards, mice, trackpads, trackballs, touchpads, touch mice, multi-touch touchpads and touch mice, microphones, multi-array microphones, drawing tablets, cameras, single-lens reflex cameras (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 130a-130n may include a combination of multiple input or output devices, including, e.g., Microsoft KINECT, Nintendo Wiimote for the WII, Nintendo WII U GAMEPAD, or Apple iPhone. Some devices 130a-130n allow gesture recognition inputs through combining some of the inputs and outputs. Some devices 130a-130n provide for facial recognition which may be utilized as an input for different purposes including authentication and other commands. Some devices 130a-130n provide for voice recognition and inputs, including, e.g., Microsoft KINECT, SIRI for iPhone by Apple, Google Now or Google Voice Search, and Alexa by Amazon.

Additional devices 130a-130n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, may have larger surfaces, such as on a table-top or on a wall, and may also interact with other electronic devices. Some I/O devices 130a-130n, display devices 124a-124n or group of devices may be augmented reality devices. The I/O devices may be controlled by an I/O controller 123 as shown in FIG. 1C. The I/O controller may control one or more I/O devices, such as, e.g., a keyboard 126 and a pointing device 127, e.g., a mouse or optical pen. Furthermore, an I/O device may also provide storage and/or an installation medium 116 for the computing device 100. In still other embodiments, the computing device 100 may provide USB connections (not shown) to receive handheld USB storage devices. In further embodiments, a I/O device 130 may be a bridge between the system bus 150 and an external communication bus, e.g. a USB bus, a SCSI bus, a Fire Wire bus, an Ethernet bus, a Gigabit Ethernet bus, a Fibre Channel bus, or a Thunderbolt bus.

In some embodiments, display devices 124a-124n may be connected to I/O controller 123. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or auto stereoscopy. Display devices 124a-124n may also be a head-mounted display (HMD). In some embodiments, display devices 124a-124n or the corresponding I/O controllers 123 may be controlled through or have hardware support for OPENGL or DIRECTX API or other graphics libraries.

In some embodiments, the computing device 100 may include or connect to multiple display devices 124a-124n, which each may be of the same or different type and/or form. As such, any of the I/O devices 130a-130n and/or the I/O controller 123 may include any type and/or form of suitable hardware, software, or combination of hardware and software to support, enable or provide for the connection and use of multiple display devices 124a-124n by the computing device 100. For example, the computing device 100 may include any type and/or form of video adapter, video card, driver, and/or library to interface, communicate, connect or otherwise use the display devices 124a-124n. In one embodiment, a video adapter may include multiple connectors to interface to multiple display devices 124a-124n. In other embodiments, the computing device 100 may include multiple video adapters, with each video adapter connected to one or more of the display devices 124a-124n. In some embodiments, any portion of the operating system of the computing device 100 may be configured for using multiple displays 124a-124n. In other embodiments, one or more of the display devices 124a-124n may be provided by one or more other computing devices 100a or 100b connected to the computing device 100, via the network 104. In some embodiments software may be designed and constructed to use another computer's display device as a second display device 124a for the computing device 100. For example, in one embodiment, an Apple iPad may connect to a computing device 100 and use the display of the device 100 as an additional display screen that may be used as an extended desktop. One ordinarily skilled in the art will recognize and appreciate the various ways and embodiments that a computing device 100 may be configured to have multiple display devices 124a-124n.

Referring again to FIG. 1C, the computing device 100 may comprise a storage device 128 (e.g. one or more hard disk drives or redundant arrays of independent disks) for storing an operating system or other related software, and for storing application software programs such as any program related to the software 120. Examples of storage device 128 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. Some storage device 128 may be non-volatile, mutable, or read-only. Some storage device 128 may be internal and connect to the computing device 100 via a bus 150. Some storage device 128 may be external and connect to the computing device 100 via a I/O device 130 that provides an external bus. Some storage device 128 may connect to the computing device 100 via the network interface 118 over a network 104, including, e.g., the Remote Disk for MACBOOK AIR by Apple. Some client devices 100 may not require a non-volatile storage device 128 and may be thin clients or zero clients 102. Some storage device 128 may also be used as an installation device 116, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

Client device 100 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 102. An application distribution platform may include a repository of applications on a server 106 or a cloud 108, which the clients 102a-102n may access over a network 104. An application distribution platform may include application developed and provided by various developers. A user of a client device 102 may select, purchase and/or download an application via the application distribution platform.

Furthermore, the computing device 100 may include a network interface 118 to interface to the network 104 through a variety of connections including, but not limited to, standard telephone lines LAN or WAN links (e.g., 802.11, TI, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 100 communicates with other computing devices 100′ via any type and/or form of gateway or tunneling protocol e.g. Secure Socket Layer (SSL) or Transport Layer Security (TLS), or the Citrix Gateway Protocol manufactured by Citrix Systems, Inc. The network interface 118 may comprise a built-in network adapter, network interface card, PCMCIA network card, EXPRESSCARD network card, card bus network adapter, wireless network adapter, USB network adapter, modem or any other device suitable for interfacing the computing device 100 to any type of network capable of communication and performing the operations described herein.

A computing device 100 of the sort depicted in FIGS. 1B and 1C may operate under the control of an operating system, which controls scheduling of tasks and access to system resources. The computing device 100 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, WINDOWS 8 and WINDOW 10, all of which are manufactured by Microsoft Corporation of Redmond, Washington; MAC OS and iOS, manufactured by Apple, Inc.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google Inc., among others. Some operating systems, including, e.g., the CHROME OS by Google Inc., may be used on zero clients or thin clients, including, e.g., CHROMEBOOKS.

The computer system 100 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 100 has sufficient processor power and memory capacity to perform the operations described herein. In some embodiments, the computing device 100 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 100 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, or a NINTENDO DS, NINTENDO 3DS, NINTENDO WII, or a NINTENDO WII U device manufactured by Nintendo Co., Ltd., of Kyoto, Japan, or an XBOX 360 device manufactured by Microsoft Corporation.

In some embodiments, the computing device 100 is a digital audio player such as the Apple IPOD, IPOD Touch, and IPOD NANO lines of devices, manufactured by Apple Computer of Cupertino, California. Some digital audio players may have other functionality, including, e.g., a gaming system or any functionality made available by an application from a digital application distribution platform. For example, the IPOD Touch may access the Apple App Store. In some embodiments, the computing device 100 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 100 is a tablet e.g. the IPAD line of devices by Apple; GALAXY TAB family of devices by Samsung; or KINDLE FIRE, by Amazon.com, Inc. of Seattle, Washington. In other embodiments, the computing device 100 is an eBook reader, e.g. the KINDLE family of devices by Amazon.com, or NOOK family of devices by Barnes & Noble, Inc. of New York City, New York.

In some embodiments, the communications device 102 includes a combination of devices, e.g. a smartphone combined with a digital audio player or portable media player. For example, one of these embodiments is a smartphone, e.g. the iPhone family of smartphones manufactured by Apple, Inc.; a Samsung GALAXY family of smartphones manufactured by Samsung, Inc; or a Motorola DROID family of smartphones. In yet another embodiment, the communications device 102 is a laptop or desktop computer equipped with a web browser and a microphone and speaker system, e.g. a telephony headset. In these embodiments, the communications devices 102 are web-enabled and can receive and initiate phone calls. In some embodiments, a laptop or desktop computer is also equipped with a webcam or other video capture device that enables video chat and video call.

In some embodiments, the status of one or more machines 102, 106 in the network 104 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the systems and methods disclosed herein.

### B. Artificial Intelligence Network and Environment

An intelligent agent is any system or device that perceives its environment and takes actions to maximize its chances of success at some goal. The term artificial intelligence is used when a machine mimics cognitive functions such as learning and problem solving. One of the tools used for artificial intelligence is neural networks. Neural networks are modeled after the neurons in the human brain, where a trained algorithm determines an output response for input signals. The main categories of neural networks are feedforward neural networks, where the signal passes only in one direction, and recurrent neural networks, which allow feedback and short-term memory of previous input events.

A wide variety of platforms has allowed different aspects of AI to develop. Advances in deep artificial neural networks and distributed computing have led to a proliferation of software libraries, including Deeplearning4j, which is open-source software released under Apache License 2.0 and supported commercially by Skymind of San Francisco, California, and TensorFlow, an artificial intelligence system which is open-source released under Apache License 2.0, developed by Google, Inc.

Deep learning comprises an artificial neural network that is composed of many hidden layers between the inputs and outputs. The system moves from layer to layer to compile enough information to formulate the correct output for a given input. In artificial intelligence models for natural language processing, words can be represented (also described as embedded) as vectors. Vector space models (VSMs) represent or embed words in a continuous vector space where semantically similar words are mapped to nearby points (are embedded nearby each other). Two different approaches that leverage VSMs are count-based methods and predictive methods. Count-based methods compute the statistics of how often some word co-occurs with its neighbor words in a large text corpus, and then maps these count-statistics down to a small, dense vector for each word. Predictive models directly try to predict a word from its neighbors in terms of learned small, dense, embedding vectors.

Neural probabilistic language models are traditionally trained using the maximum likelihood (ML) principle to maximize the probability of the next word given previous words (or context) based on the compatibility of the next word with the context. The model is trained by maximizing its log-likelihood on a training set. The objective is maximized when the model assigns high probabilities to the words which are desired (the real words) and low probabilities to words that are not appropriate (the noise words).

A framework is provided that allows a model builder to express a machine learning algorithm symbolically, wherein the machine learning algorithm is modeled as a computation graph. This can interface with a set of Python classes and methods that provide an API interface, resulting in re-targetable systems that can run on different hardware.

The learned values from the recurrent neural network may also be serialized on disk for doing the inference step at a later time. These learned values are stored in multidimensional arrays that also contain shape and type information while in memory. The TensorFlow software libraries call these multidimensional arrays tensors.

The following describes systems and methods of creating, controlling and executing simulated phishing campaigns using artificial intelligence.

A system can be configured to send multiple simulated phishing emails, text messages, phone calls (e.g. via VoIP) and Internet based communications, varying the quantity, frequency, type, sophistication, content, timing, and combination of messages using machine learning algorithms or other forms of artificial intelligence. Such a system may be referred to as an artificial intelligence driven agent system, or AIDA system, or simply a system. The set of phishing emails, text messages, and/or phone calls may be referred to as a simulated phishing campaign. In some implementations, some or all messages (email, text messages, VoIP calls, Internet based communications) in a simulated phishing campaign after the first simulated phishing message may be used to direct the user to open the first simulated phishing message, or to open the latest simulated phishing message. In some implementations, simulated phishing messages of a campaign may be intended to lure the user to perform a different requested action, such as selecting a hyperlink in an email or text message, or returning a voice call.

In some implementations, the system may adaptively learn the best method (e.g., set of steps) and/or the best combination of messages to get the user to perform the requested action, such as interacting with a hyperlink or opening a file. The learning process implemented by the system can be trained by observing the behavior of other users in the same company or in the same industry, by observing the behavior of all other users of the system, or by observing the behavior of a subset of other users in the system based on one or more attributes of the subset of other users meeting one or more selected criteria.

The system can record when and how the action was performed and can produce reports about the actions. The reports can track the number of users the simulated messages were sent to, whether messages were successfully delivered, whether a user performed a requested action, when a requested action was performed, and a combination and timing of messages that induced a user to perform a requested action. In some implementations, the system may provide training on why a user should not have performed a requested action at the time that the user performs the requested action.

An AIDA system may use information from many sources to create, train, and refine artificial intelligence models to create simulated phishing messages for users. As examples, an AIDA system may extract information from the past efficiency of templates that have been used to phish users. An AIDA system may extract information that was made public due to a data breach. An AIDA system may extract information from past user communications with a security awareness system. An AIDA system may use information from user profiling, for example language, gender, political affiliation, interests and career information. An AIDA system may use information found on social media. An AIDA system may use information from logs from previous simulated phishing campaigns, including all actions performed on a user and all user actions performed. An AIDA system may use information from event logs, for example Windows event logs. An AIDA system may use information from learning management system (LMS) analysis, which may inform the AIDA systems as to exactly what training a user has had, where the user performed well and where the user struggled with the training that the user completed, and what the user should know. An AIDA system may use information from company profiling activities, for example email exposure check results, applications used, software as a service (SaaS) services used, etc. An AIDA system may use information from industry profiles corresponding to an industry that a user's company is associated with.

In some embodiments, an AIDA system is capable of performing risk analysis of users, groups of users, or a company. For example, an AIDA system may be able to perform a risk profile of a user with respect to wire transfer fraud, or IP theft. In some embodiments, an AIDA system can track events in a company and/or for a user in a company to identify one or more risk points. In some embodiments, an AIDA system can track information that a given user is exposed to in order to identify a risk point. For example, employees in a company that regularly deal with wire transfers may be likely to be at a higher risk for wire transfer fraud, and people that are exposed to sensitive information may be at a higher risk for leaking intellectual property.

In some embodiments, an AIDA campaign duration is limited to a fixed period of time, for example a fixed number of days. In some embodiments, an AIDA campaign will terminate once a certain percentage of users fail the campaign. In some embodiments, an AIDA campaign will terminate if a certain percentage of users fail the campaign in a first period of time. In some embodiments, an AIDA campaign stops for a specific user once that user fails a simulated phishing test as part of the campaign.

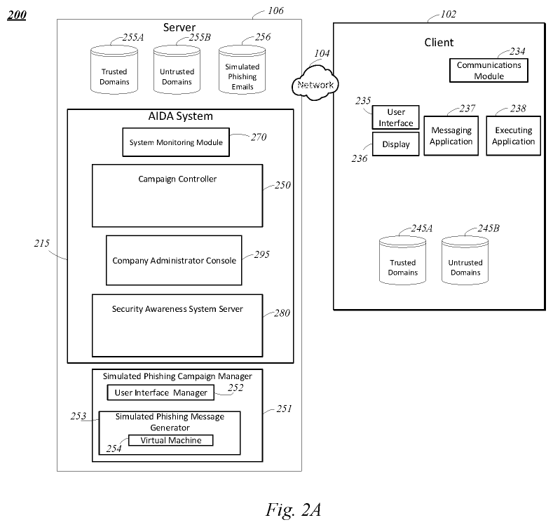

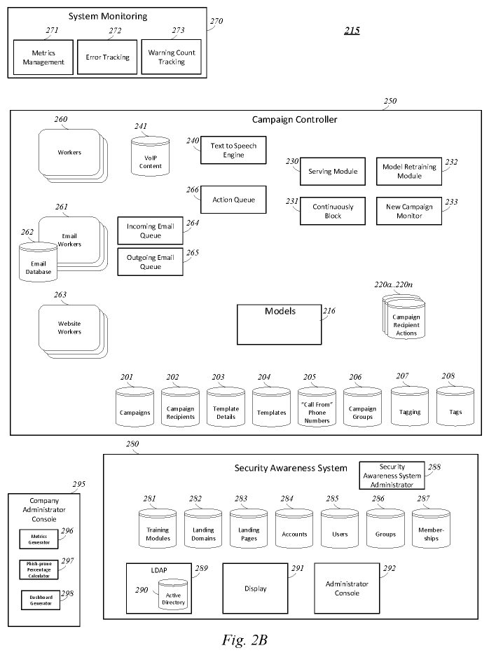

Referring to FIG. 2A in a general overview, FIG. 2A depicts some of the architecture of an implementation of a system 200 capable of creating, controlling and executing simulated phishing campaigns using artificial intelligence. In some implementations, the system 200 includes a server 106 and a client 102 and a network 104 allowing communication between these system components. The server 106 may include an AIDA system 215, a simulated phishing campaign manager 251, a trusted domains storage 255A, an untrusted domains storage 255B, and a simulated phishing emails storage 256. The AIDA system 215 may include a system monitoring module 270, a campaign controller 250, a company administrator console 295, and a security awareness system server 280. The simulated phishing campaign manager 251 may include a user interface manager 252 and a simulated phishing message generator 253. The simulated phishing message generator 253 may include a virtual machine 254. The client 102 may include a communications module 234, a user interface 235, a display 236, a messaging application 237, an executing application 238, a storage for trusted domains 245A, and a storage for untrusted domains 245B.

The server 106 may be a part of a cluster of servers 106. In some embodiments, tasks performed by server 106 may be performed by a plurality of servers. These tasks may be allocated among the plurality of servers by an application, service, daemon, routine, or other executable logic for task allocation. The server 106 may include a processor and memory. Some or all of server 106 may be hosted on cloud 108, for example by Amazon Web Services (AWS).

Each of the server 106, the AIDA system 215, and the simulated phishing campaign manager 251, and any components or modules thereof, may comprise a program, service, task, script, library, application, or any type and form of executable instructions or code executable on one or more processors. Any of the server 106, the AIDA system 215, and/or the simulated phishing campaign manager 152 may be combined into one or more modules, applications, programs, services, tasks, scripts, libraries, applications, or executable code.

The simulated phishing campaign manager 251 includes a simulated phishing message generator 253, which may be implemented as or contain a virtual machine 254. Responsive to a user input, the simulated phishing campaign manager 251 generates a campaign for a simulated phishing attack, including one or more selected phishing message templates, one or more selected landing page templates, and one or more selected targeted user groups, in addition to other user input.

The simulated phishing campaign manager 251 may manage various aspects of a traditional simulated phishing attack campaign, for example a simulated phishing attack campaign that does not use an artificial intelligence driven agent (AIDA). For example, the simulated phishing campaign manager 251 may process input from the server 106 and/or may provide access as needed to various applications, modules, and other software components of server 106 to other various applications, modules, and other software components of server 106. The simulated phishing campaign manager 251 may monitor and control timing of various aspects of a simulated phishing attack campaign, may process requests for access to simulated attack campaign results, and/or may perform other tasks related to the management of a simulated phishing attack campaign.

In some embodiments, the simulated phishing campaign module 251 may be integrated with or coupled to memory 122. In some embodiments, the memory may include any type and form of storage, such as a database or file system. The memory 122 may store data such as parameters and scripts corresponding to the choices made by a server 106 through a simulated phishing campaign manager 251, e.g. as described above for a particular simulated phishing attack.

In an implementation, the simulated phishing campaign manager 251 includes a simulated phishing message generator 253. The simulated phishing message generator 253 may be integrated with or coupled to the memory 122 so as to provide the simulated phishing message generator 253 access to parameters associated with messaging choices made for a particular simulated campaign by e.g. the server 106. The simulated phishing message generator 264 may be integrated with or coupled to memory or a memory store or otherwise a storage, such as a database, containing simulated phishing emails 256. The simulated phishing message generator 253 may be an application, service, daemon, routine, or other executable logic for generating messages. The messages generated by the simulated phishing message generator 253 may be of any appropriate format. For example, they may be email messages, test or SMS messages, messages used by particular messaging applications such as, e.g. WhatsApp™, or any other type of message. Message types to be used in a particular attack may be selected by e.g. a server 106 using a simulated phishing campaign manager 251. The messages may be generated in any appropriate manner, e.g. by running an instance of an application that generates the desired message type, such as running e.g. a Gmail™ application, Microsoft Outlook™, WhatsApp™, a text messaging application, or any other appropriate application. The messages may be generated by running a messaging application on e.g. a virtual machine 254, or may simply be run on an operating system of the server 106, or may be run in any other appropriate environment. The messages may be generated to be formatted consistent with specific messaging platforms, for example Outlook 365, Outlook Web Access (OWA), Webmail, iOS, Gmail client, and so on.

In some embodiments, the simulated phishing message generator 253 can be configured to generate messages having the ability to traverse users who interact with the messages to a specific landing page.

In some embodiments, the simulated phishing message generator 253 can be configured to generate a simulated phishing email. The email can appear to be delivered from a trusted email address, such as the email address of an executive of the company at which the targeted user is employed. In addition, the email can have a “Subject:” field that is intended to cause the user to take an action, such as initiating a wire transfer. In some embodiments, the simulated phishing message generator 253 can generate one or more simulated phishing emails which are stored in the simulated phishing emails storage 256. In some embodiments, the simulated phishing message generator 253 can generate multiple instances of the email which may be delivered to multiple users, such as a subset of all of the employees of the company. In some embodiments, the simulated phishing message generator 253 can generate multiple instances of the email which may be delivered to a user group. For example, the server 106 can select any number of employees who should be targeted by a simulated attack, can create a user group and store this user group in the memory 122. The simulated phishing message generator 253 can retrieve this information from the memory 122 and can generate a set of emails similar to the email, each addressed to a respective target identified in the information stored in the memory 122. That is, the simulated phishing message generator 253 can generate the emails such that the “From:” and “Subject:” fields of each email are identical, while the “To:” field is adjusted according to the desired targets.

In an implementation, a simulated phishing campaign manager 251 may be e.g., another name for a system administrator, such as a security manager, a third-party security consultant, a risk assessor, or any other party that uses the simulated phishing campaign manager 251 installed on a server. The server 106 may wish to direct a simulated phishing attack by interacting with the simulated phishing campaign manager 251 installed on the server. The simulated phishing campaign manager 251 may be, for example, a desktop computer, a laptop computer, a mobile device, or any other suitable computing device. The simulated phishing campaign manager 251 may be e.g., an application on a device that allows for a user of the device to interact with the server 106 for e.g., purposes of creating, configuring, tailoring and/or executing a simulated phishing attack and/or viewing and/or processing and/or analyzing the results of a phishing attack.

In an implementation, the simulated phishing campaign manager 251, when executed, causes a graphical user interface to be displayed to the server 106. In other embodiments, the simulated phishing campaign manager 251 allows for user input through a non-graphical user interface, such as a user interface that accepts text or vocal input without displaying an interactive image. A graphical user interface may be displayed on a screen of a mobile phone, or a monitor connected to a desktop or laptop computer, or may be displayed on any other display. The user may interact with e.g., the graphical user interface on the device by typing, clicking a mouse, tapping, speaking, or any other method of interacting with a user interface. The graphical user interface on the device may be a web-based user interface provided by a web browser (e.g., Google Chrome, Microsoft Internet Explorer, or Mozilla Firefox provided by Mozilla Foundation of Mountain View, California), or may be an application installed on a user device capable of opening a network connection to simulated phishing campaign manager 251, or may be any other type of interface.

In an implementation, the simulated phishing campaign manager 251 and/or server 106 may make choices concerning how a simulated phishing attack is to be carried out. For example, a graphical user interface run by the simulated phishing campaign manager 251 may be displayed to the server 106. An administrator, via the server 106, may input parameters for the attack that affect how it will be carried out. For example, via the server 106 an administrator may make choices as to which users to include as potential targets in the attack, the method of determining which users are to be selected as targets of the attack, the timing of various aspects of the attack, whether to use an attack template that includes values for one or a plurality of failure indicators, how responses from targeted users should be uniquely identified, and other choices. These choices may be made by selecting options displayed on a graphical user interface from dropdown menus, being presented with choices through a simulated attack wizard, or in any other appropriate manner.

In an implementation, the simulated phishing campaign manager 251 may allow the server 106, such as via application programming interfaces (APIs), to access and/or change settings of an account maintained with any party involved with the attack, such as, for example, a third party security service provider, or may allow the server 106 to access and/or change settings of an account maintained with a third party security service provider, such as one that e.g. manages an exploit server, view bills and/or make payments to a third party security service provider, to perform these functions with other third parties involved in the attack, or provide any other functions that would be appropriate for facilitating communications between the server 106 and any other parties involved in the attack.

The system 200 also includes the client 102. A client may be a target of any simulated phishing attack. For example, the client may be an employee, member, or independent contractor working for an organization that is performing a security checkup or conducts ongoing simulated phishing attacks to maintain security. The client 102 may be any device used by the client. The client does not need to own the device for it to be considered a client device 102. The client 102 may be any computing device, such as a desktop computer, a laptop, a mobile device, or any other computing device. In some embodiments, the client 102 may be a server or set of servers accessed by the client. For example, the client may be the employee or a member of an organization. The client may access a server that is e.g., owned or managed or otherwise associated with the organization. Such a server may be a client 102.

In some implementations, client 102 may include a communications module 234. This may be a library, application programming interface (API), a set of scripts, or any other code that may facilitate communications between the client 102 and any of the server 106, a third-party server, or any other server. In some embodiments, the communications module 234 determines when to transmit information from the client 102 to the external servers via a network 104. In some embodiments, the information transmitted by the communications module 264 may correspond to a message, such as an email, generated by the messaging application 237.

In some embodiments, the client 102 may include a user interface 235 such as a keyboard, a mouse, a touch screen, or other appropriate user interface. This may be a user interface that is e.g., connected directly to a client 102, such as, for example, a keyboard connected to a mobile device, or may be connected indirectly to a client 102, such as, for example, a user interface of a client device used to access a server client 102. The client may include a display 236, such as a screen, a monitor connected to the device in any manner, or any other appropriate display.

In an implementation, the client 102 may include a messaging application 237. The messaging application 237 may be any application capable of viewing, editing, and/or sending messages. For example, the messaging application 237 may be an instance of an application that allows viewing of a desired message type, such as any web browser, a Gmail™ application, Microsoft Outlook™, WhatsApp™, a text messaging application, or any other appropriate application. In some embodiments, the messaging application 237 can be configured to display simulated phishing attack emails. Furthermore, the messaging application 237 can be configured to allow the target to generate reply messages or forwarded messages in response to the messages displayed by the messaging application 237.

The client 102 may include storage for trusted domains 245A and untrusted domains 245B. Each of the client 102, messaging application 237, executing application 238, client service 242, and user console 243 may comprise a program, service, task, script, library, application or any type and form of executable instructions or code executable on one or more processors. Any of the client 102, messaging application 237, executing application 238, client service 242, and/or user console 243 may be combined into one or more modules, applications, programs, services, tasks, scripts, libraries, applications, or executable code.

The client 102 receives messages sent by the server 106 based upon the campaign created and executed by the simulated phishing campaign manager 251 and/or by the AIDA system 215. The client 102 is able to receive the simulated phishing messages via the messaging application 237, display the received messages for the user using the display 236, and is able to accept user interaction via the user interface 235 responsive to the displayed message. In some embodiments, if the user interacts with the simulated phishing message, the client traverses to a landing page selected for the phishing campaign.

Referring to FIG. 2B, in a general overview, FIG. 2B depicts some of the architecture of an implementation of an AIDA system 215 capable of creating, controlling and executing simulated phishing campaigns using artificial intelligence. The AIDA system 215 may include a system monitoring module 270, a campaign controller 250, a company administrator console 295, and a security awareness system server 280. The system monitoring module 270 may include metrics management 271, error tracking 272, and warning count tracking 273. The company administrator console 295 may include metrics generator 296, phish-prone percentage calculator 297, and dashboard generator 298. Security awareness system server 280 may include security awareness system administrator 288, LDAP 289, active directory 290, a display 291, and an administrator console 292. Security awareness system server 280 may include a training modules storage 281, a landing domains storage 282, a landing pages storage 283, an accounts storage 284, a users storage 285, a groups storage 286, and a memberships storage 287. Campaign controller 250 may include a serving module 230, a continuously block 231, a model retraining module 232, and a new campaign monitor 233. Campaign controller 250 may include workers 260, email workers 261, and website workers 263. Campaign controller 250 may include a text to speech engine 240, an action queue 266, and incoming email queue 264, and an outgoing email queue 265. Campaign controller 250 may include a campaigns storage 201, a campaign recipients storage 202, a template details storage 203, a templates storage 204, a “call from” phone numbers storage 205, a campaign groups storage 206, a tagging storage 207, a tags storage 208, a models storage 216, one or more campaign recipient actions table storages 220a . . . 220n, a VoIP content storage 241, and an email database 262.

Any of the AIDA system 215, the system monitoring module 270, the campaign controller 250, company administrator console 295, a security awareness system server 280, the metrics management 271, error tracking 272, and warning count tracking 273 may comprise one or more a program, service, task, script, library, application, or any type and form of executable instructions or code executable on one or more processors.

In some embodiments, the system monitoring module or system monitor 270 keeps track of the health of functional blocks of the system 200. In some embodiments, the system monitoring module monitors the delays, queues, loads, and other parameters of the system 200, such that the security awareness system administrator 288 can keep track of the system 200. In some embodiments, the system monitoring module 270 includes metrics management 271, which keeps track of any performance metrics for any functional block or module in the system. In some embodiments, metrics management 271 keeps track of the number of messages processed in a given unit of time. In some embodiments, metrics management 271 keeps track of how many instances of each functional block are in use at a given time. In some embodiments, metrics management 271 keeps track of how many of each type of messages were sent. In some embodiments, metrics management 271 keeps track of how many actions were stored in the one or more actions table(s). In some embodiments, metrics management 271 keeps track of how many messages or different types were put into different queues. In some embodiments, the system monitoring module 270 includes error tracking 272. In some embodiments, error tracking 272 keeps track of actions in a queue which are not processed. In some embodiments, error tracking 272 keeps track of user email addresses that are incorrect. In some embodiments, error tracking 272 raises an error if the system monitoring module 270 cannot access one or more databases. In some embodiments, the system monitoring module 270 includes warning count tracking 273. In some embodiments, warning count tracking 273 keeps track of the number of warnings that have occurred in a period of time.

The data identified, monitored, obtained or processed by the system monitoring module may be stored in any type and form of database, files or logs. In some embodiments, such data may be stored in a time series type or based database. In some embodiments, the data for the system monitoring module may be stored in an open source time series database that is optimized for fast, high-availability storage and retrieval of time series data. An example of an open-source time series database is INFLUXDB, which is written in programming language GO and is provided by InfluxData of San Francisco, California. In some embodiments, the time series database is hosted in the cloud. In some embodiments, the time series database is local to the server 106.

The data that is stored by the system monitoring module may be processed, analyzed and displayed via a tool and/or user interface. The tool and/or user interface may allow and/or provide for a system administrator to query and alert on metrics and create a managed dashboard to visually display the data and metrics. In some embodiments, the time series data that is accessed by the system monitoring module is analyzed and visually displayed using an open source software platform to allow a security system administrator 288 to query and alert on metrics and to create dashboards to visually display time series data. An example of an open source software platform for time series analytics and visualization is Grafana, which is provided by GrafanaLabs (formerly known as Raintank) of New York, New York. In some embodiments, the analytics and visualization platform is hosted in the cloud. In some embodiments, the analytics and visualization platform is hosted locally on the server 106. In some embodiments, the analytics and visualization platform is an open source platform. In some embodiments, the analytics and visualization platform is proprietary to the security awareness system provider. In some embodiments, the system monitoring module 270 retrieves the time series data in one or more folders on the server 106. In some embodiments, the system monitoring module 270 uses plug-ins to retrieve the time series data. In some embodiments, the system monitoring modules uses an API to enable a loading mechanism to retrieve the data.

In some embodiments, more than one instance of the system monitoring module 270 may exist. In some embodiments, there exists one or more instance of the system monitoring module 270 to monitor one or more model managers 370. In some embodiments, there exists one or more instance of the system monitoring module 270 to monitor the operation of one or more campaign controllers 250. In some embodiments, one or more instance of the system monitoring module 270 monitors both the model creation and the operation of the campaign controller 250. In some embodiments, one or more instance of the system monitoring module 270 keeps track of the health of one or more workers 260, one or more email workers, 261, one or more serving modules 230, one or more model controllers 320, and one or more Q&A workers 315.

AIDA system 215 may include a company administrator console 295. The company administrator console 295 enables an administrator of an account to create an AIDA simulated phishing campaign (also referred to as an AIDA campaign) using a user interface, such as graphical user interface or command line interface, and/or an application programming interface (API). In some embodiments, the company administrator, via the company administrator console 295, inputs the date and time that they want the AIDA campaign to start. In some embodiments, the company administrator inputs the time zone for the AIDA campaign. In some embodiments, the company administrator selects whether or not the AIDA campaign should allow text messages. In some embodiments, the company administrator selects whether or not the AIDA campaign should allow VOIP calls. In some embodiments, the company administrator selects the user groups that are to be included in the AIDA campaign. In some embodiments, the company administrator can select from one or more pre-existing user groups. In some embodiments, the company administrator can select from one or more users to create a new user group.

In some embodiments, the company administrator console 295 includes metrics generator 296 which tracks metrics about what happened in the AIDA campaign. In some embodiments, metrics generator 296 tracks the number of users of the AIDA campaign. In some embodiments, metrics generator 296 tracks the number of VoIP calls made in the AIDA campaign. In some embodiments, metrics generator 296 tracks the number of text messages sent in the AIDA campaign. In some embodiments, metrics generator 296 tracks the number of emails sent in the AIDA campaign. In some embodiments, metrics generator 296 tracks the number of user interactions with links in the AIDA campaign.

In some embodiments, the company administrator console 295 includes a metric generator or calculator 296, such as a phish-prone percentage calculator 297. The metric generator may establish, generate or calculate any type and form of metrics and/or statistics related to any of the data for any simulated phishing campaigns, any data processed, identified or provided by the campaign controller and/or and data stored in any of the models, and/or any data stored in any of the databases described herein. The metric generator may establish, generate or calculate any type and form of metrics and/or statistics related to any of the data stored in, with or associated with any of the following for example: campaign recipient actions 220, campaigns 201, campaign recipients 202, template details 203, templates 204, “call from” phone numbers 205, campaign groups 206, tagging 207, tags 208, training modules 281, landing domains 282, landing pages 283, accounts 284, users 285, groups 286, memberships 287, trusted domains 245 and 255, untrusted domains 245 and 255, simulated phishing emails 256, any of the models 216, metagraph 361, Q&A pairs 350, approved Q&A pairs 351, neurons 363, training Q&A pairs 352, Testing Q&A pairs 353, all configuration super parameters 363, groups 286, memberships 287, accounts 284 and users 285. The metrics and/or statistics may include any type and form of average, mean, summation, percentages, count and/or function of any one or more data items or combination of data items including over any time period or frequency or temporal parameters.

In some embodiments, phish-prone percentage calculator 297 calculates a phish-prone percentage as the percentage of users that interacted with a link in the AIDA campaign out of the total number of users that received messages as part of the campaign. In some embodiments, phish-prone percentage calculator 297 calculates a phish-prone percentage as the percentage of messages for which a user interacted with a link in the message as part of the AIDA campaign out of the total number of messages sent in the AIDA campaign. In some embodiments, phish-prone percentage calculator 297 calculates the phish-prone percentage across all of the campaigns that have been executed for the company. In some embodiments, phish-prone percentage calculator 297 calculates the phish-prone percentage for the most recent AIDA campaign for the company.

In some embodiments, the company administrator console 295 includes dashboard generator 298. In some embodiments, dashboard generator 298 displays an overview page which displays information about an AIDA campaign. In some embodiments, dashboard generator 298 generates a display of the number of times a user interacts with a link in a simulated phishing message that is part of an AIDA campaign over a given time period after the start of the AIDA campaign. In some embodiments, dashboard generator 298 generates a display of the number of times a user has interacted with a link in each of the first number of time periods after the start of an AIDA campaign. In some embodiments, the time period is one hour. In some embodiments, dashboard generator 298 displays a circle with a size that is proportionate to the number of interactions with a simulated phishing message in a time period, wherein the greater the number of user interactions with links in simulated phishing messages, the larger the size of the circle that is displayed. In some embodiments, dashboard generator 298 displays the status of the AIDA campaign as one of stopped, started, paused, ongoing, discontinued, completed, finished, cancelled, restarted, or aborted. In some embodiments, dashboard generator 298 displays the date and time that an AIDA campaign was created on. In some embodiments, dashboard generator 298 displays the date an AIDA campaign was started on. In some embodiments, dashboard generator 298 displays the end date of an AIDA campaign. In some embodiments, if the campaign is one of stopped, paused, ongoing, discontinued, cancelled, restarted, or aborted, the end date is displayed as “Not Finished”. In some embodiments, the company administrator can highlight a specific recipient and see all the actions performed on that recipient (e.g. messages sent to the recipient, what detail page was used, when the message was sent, etc.) and all the actions that the recipient performed (e.g. clicked on a link in a text message, responded to an email, etc.). For example, if there is an entry in the one or more campaign recipient actions table(s) indicating that the campaign controller 250 sent them an email, then the company administrator can click on this action and the company administrator console 295 displays a copy of the detail page of the template that was used to generate the email that the user received.

In some embodiments, dashboard generator 298 displays information about the browser, agent or platform that the user uses to view the messages of a campaign. In some embodiments, dashboard generator 298 displays information about multiple user's browsers, agents, or platforms in a pie chart format.

In some embodiments, dashboard generator 298 displays a user page which displays an AIDA campaign report which individually shows actions associated with each of the recipients of the AIDA campaign. In some embodiments, dashboard generator 298 displays one or more metrics of the campaigns across one or more tabs, and when a company administrator clicks on one of the tabs, more detailed information is shown to the company administrator. In one embodiment, dashboard generator 298 generates one or more tabs for AIDA campaign recipients, emails sent, emails delivered, emails opened, emails clicked, emails bounced, SMS messages sent, SMS messages clicked, SMS message errors, phone calls made, and phone call errors. In one embodiment, when the company administrator selects the recipients tab, the dashboard generator displays a list of the email addresses of all of the recipients of the AIDA campaign and an indication of whether or not they failed the campaign.

Referring briefly to FIGS. 2C, 2D and 2E are examples of user interfaces and/or dashboards for displaying metrics and statistics about simulated phishing campaigns. An administrator can click on any of the tabs of the example user interfaces to see any of the following information, including any details for the same: EMAILS DELIVERED, EMAILS OPENED, EMAILS CLICKED, EMAILS BOUNCED, SMS SENT, SMS CLICKED, SMS ERRORS, PHONE CALLS MADE, PHONE CALL ERRORS. The administrator can see for each user each email the user received, if the user clicked on a link in the email and/or each SMS sent, and/or each phone call placed. If the administrators clicks or hovers over any of the information indicators in the user interface of FIGS. 2C-2E, the system will provide more information on the cause of the error or issue.

AIDA system 215 may include a security awareness system 280 running on one or more servers, sometimes also referred to as security awareness system server. The security awareness system 280 may comprises one or more applications, programs, services, processes, libraries or any type and form of executable instructions executable on one or more computing devices. Security awareness system 280 provides a user interface for the security awareness system administrator 288 through the administrator console 292. In some embodiments, the administrator console 292 provides an interface for the security awareness system administrator 288 to make updates on one or more of the campaign controllers 250 and the workers 260 to enable the use of a specific version of a model. In some embodiments, the administrator console 292 on the security awareness system 280 provides an interface for security awareness system administrator 288 to add new versions of template detail pages for one or more templates. In some embodiments, the administrator console 292 on the security awareness system 280 provides an interface for security awareness system administrator 288 to specify the usage percentage for one or more template detail pages of a template, such that each template detail page gets used a specified percentage of the time. In some embodiments, the usage percentages for specific template detail pages and/or specific versions of template detail pages are calculated using count values for records that have the same template detail ID. Each time the template detail ID gets used, the percentage that each version of the template detail page has been used is calculated using the count values. The version of the template detail ID page that is the greatest amount less than the target usage percentage gets used in creating the message. In some embodiments, when the security system administrator 288 adds one of a new template detail page and a new version of a template detail page, the count values of records with the same template detail ID are set to zero.

In some embodiments, the security awareness system 280 includes display 291. The display 291 may provide a user interface and/or dashboard to show or display any results from execution of simulated phishing campaigns and allow a user to review any such results. In some embodiments, display 291 is used to display system information provided by the system monitoring module 270. In some embodiments, the display provides an administrator console interface or user interface from which a user can edit, create, and/or manage one or more of the following: accounts, phishing templates, landing pages, landing domains, templates, such as AIDA or training templates, training modules and any of the other components, modules, functions of any of the system described herein.

In some embodiments, the security awareness system 280 includes an active directory 290 and LDAP 289 and/or interfaces to an active directory 290 running or operating on one or more other devices using an LDAP (Lightweight Directory Access Protocol) protocol 289. In some embodiments, LDAP 289 is the protocol used to communicate with active directory 290. In some embodiments, LDAP 289 is a service that implements LDAP and provides services to access LDAP based systems, such as the active directory. In some embodiments, the server of the security awareness system implements or provides the active directory. In some embodiments, another server implements or provides the active directory. The security awareness system interfaces or accesses the active directory 290 to identify, obtain and/or extract user information, such as email address, first and last name, location, manager information and any other information about the user stored in the active directory. Any information stored or provided by the active directory 290 may be used by the campaign controller for creating, managing or executing simulated phishing campaigns. In some embodiments, the campaign controller accesses or interfaces to the active directory 290, such as via LDAP. In some embodiments, the campaign controller communicates or interfaces with the security awareness system to obtain the user information from the active directory 290. In some embodiments, users may be imported or added manually, such as if an active directory is not used.

In some embodiments, the security awareness system 280 includes a storage for training modules 281. In some embodiments, the security awareness system 280 includes a storage for landing domains 282. The security awareness system may store any of the training modules and/or landing domains in any type and form of database, including cloud based storage or local storage.

In some embodiments, the security awareness system 280 includes a storage for landing pages 283. A landing page may comprise a uniform resource locator or domains constructed to identify or point back to a server or system maintained or known by the server 280 and/or campaign controller. In some embodiments, the URL or domain identifies a tracking service or server of the system used for tracking. In some embodiments, the URL or domain is constructed to mimic, masquerade, disguise or simulate a domain or URL they are not. In some embodiments, the data structure for the landing page information stored for each landing page in the landing pages storage 283 includes one or more of a landing page ID, the HTML content of the landing page, the title of the landing page, one or more identifiers of the landing page, the account (company) ID that the landing page is to be used for, the landing page category ID, the date and time the landing page was created at, and the date and time the landing page was updated at. The categories identified by the category ID for the landing pages can be any predetermined category provided by the system or user generated or specified categories. The landing page categories may be used to group landing pages based on common traits or attributes. Some examples of categories include but are not limited to: point of failure video training, phishing for sensitive information, and error pages. The categories may be based on a type of campaigns, templates, models, personas, companies, groups of users or attributes of any of the foregoing. In some embodiments, landing pages may be assigned to one category, while in other embodiments, landing pages may be assigned to multiple categories.

In some embodiments, the security awareness system 280 includes a storage for accounts 284. In some embodiments, the data structure for the account information stored for each account in accounts storage 284 includes one or more of an account ID, a company name, a company address, a company phish-prone percentage, an industry ID, a company size, the business hours for the company, the days of the week that the company operates, the region of the company, and the time zone of the company. In some embodiments, the account storage 284 is a relational database. In some embodiments, the account storage relational database 284 has a relationship with users storage 285, wherein the relationship links one or more user records from users storage 285 to an account ID. In some embodiments, account storage relational database 284 has a relationship with groups storage 286, wherein the relationship links one or more group records from groups storage 286 to an account ID. In some embodiments, the account storage relational database 284 has a relationship with campaigns storage 201, wherein the relationship links one or more campaign records from campaigns storage 201 to an account ID.

In some embodiments, the security awareness system 280 includes a storage for users 285. In some embodiments, the data structure of the user information stored for each user in users storage 285 includes one or more of a user ID, a user email address, the account ID associated with a user, a user's name, a user's job title, a user's phone number, a user's mobile phone number, a user's location, what time zone a user is in, a user's division, a user's manager's name, a user's manager's email address, a user's employee number, a user's gender, and the date and time that a user's record was created and/or updated.

In some embodiments, the security awareness system 280 includes a storage for groups 286. In some embodiments, the data structure of the group information stored for each group in groups storage 286 includes one or more of a group ID, an account ID associated with a group, a name of the group, and a date and time that the group record was created and/or updated. In some embodiments, groups storage 286 is a relational database. In some embodiments, groups storage relational database 286 has a relationship with users storage 285, wherein the relationship links one or more users from users storage 285 to a group ID.

In some embodiments, the security awareness system 280 includes a storage for memberships 287. In some embodiments, membership storage 287 is a relational database which links users to groups. In some embodiments, the data structure of the membership information stored in memberships storage 287 includes one or more of a membership ID, a user ID, a group IP, and a date and time that a membership record was created and/or updated. In some embodiments, memberships storage 287 lists which users are in which groups. In some embodiments, a user can be in multiple groups.

AIDA system 215 may include one or more campaign controllers 250. In some embodiments, the campaign controller includes a serving module 230. The campaign controller includes, is configured with or implemented to have any of the instructions, function and/or logic to perform the operations and functionality of the campaign controller described herein, such as creating, managing and executing a simulated phishing campaign In some implementations, the serving module is the intelligent engine or brain of campaign controller 250 that receives and processes input related to a campaign and provides output regarding the operation, instruction or functions for a campaign The serving module 230 uses information, such as from any of the storage or databases described herein, to design a customized AIDA simulated phishing campaign for a given user, such as a campaign that is likely to have the highest probability of getting that specific user to interact with a link. The serving module may use information about any results from executing simulated phishing campaigns for that user and/or other users.

In some embodiments, design choices for an AIDA campaign include choice of model, choice of template including detail pages that will get used, when to start the campaign, duration of the campaign, frequency or how often to test a campaign recipient, type(s) of communications or messages (e.g., email, text, VoIP, etc.) of the campaign and a timing of the campaign. In some embodiments, the choice of a template for a given user may be made based on user attributes, or it may be randomly selected. In some embodiments, templates are available in advance, and each template could have any number of emails, text or VoIP calls, in any order. In some embodiments, the detailed pages and steps in a campaign are pre-determined when a template is created. In some embodiments, a state machine progresses an AIDA campaign through each stage of a template, performing actions that need to be performed with timing that is associated with that template. For example, the stages of a template may be “send an email”, followed by “send a text”, followed by “call”. The template gets worked through from front to back until a user action occurs which indicates that they have failed the test and need to go for training. As soon as a user interacts with a link, the AIDA campaign for that user stops. A template may have any number of steps and any combination of different message types. In one embodiment, a template comprises one of each of an email, an SMS or text message, and a VoIP call.

In some embodiments, serving module 230 will provide to a campaign controller 250 combinations of data about the user and campaign controller 250 may use that data to further customize an AIDA campaign for that user. In some embodiments, data may include information about the back-off time to be used between messages, information about specific detail pages related to a template for a model selected for the user, and information representing specific wording of messages that are sent to the user. In some embodiments, serving module 230 knows which model and version of the model to use for a given user in a given campaign through reading information from template details storage 203. In some embodiments, serving module 230 periodically polls one or more model storages 216 in order to determine if a new model is available or a new version of a model is available. In some embodiments, serving module 230 will load the new model or the new version of the model to memory so that the model can be used by campaign controller 250. Multiple models can be loaded at one time, and multiple versions of a single model can be loaded at one time. In some embodiments, serving module 230 can view and access all models and all versions of all models.

In some embodiments, serving module 230 determines or selects a persona model from models storage 216 with which to phish a given AIDA campaign recipient for a given AIDA campaign. In some embodiments, serving module determines or selects a persona model that meets one or more criteria or threshold for a rate of success for a user or group of users. In some embodiments, serving module determines or selects a persona model that is more likely or most likely, such as via machine learning, to cause a user or group of users to interact with a link of a simulated phishing communication or message. In some embodiments, serving module 230 determines one or more templates and one or more detail pages within the one or more templates with which to phish a given AIDA campaign recipient for a given AIDA campaign. In some embodiments, serving module 230 determines one or more frequencies of an AIDA campaign and/or one or more timings of an AIDA campaign with which to phish a given AIDA campaign recipient for a given AIDA campaign. In one embodiment, serving module 230 determines one or more training modules for a user to undergo if the user fails a given AIDA campaign. In some embodiments, the model comprises a neural network that was created during a training process, combined with a metagraph which is a set of functions and parameters to call. In some embodiments, a metagraph is stored in metagraph storage 361. The metagraph stores may comprise a text file or a Protobuf file. In some embodiments, serving module 230 identifies, specifies or provides the set of functions and/or parameters to call, to execute the model.

In some embodiments, an AIDA campaign has a defined order in which to take actions for a campaign recipient, which is defined by a template. A template may comprise any type and form of data structure, configuration and/or parameters, set of data, policies and/or rules for specifying how to create, execute and/or manage a simulated phishing campaign. The template may specify any of the design choices for the campaign, including but not limited to model, template, detail pages that will get used, when to start the campaign, duration of the campaign, frequency or how often to communicate with a campaign recipient, type(s) of communications or messages (e.g., email, text, VoIP, etc.) of the campaign, order of communications/messages and a timing of the campaign, including any timing between communications/messages.

In some embodiments, campaign controller 250 may create a template for an AIDA campaign as the campaign is running based on a user's actions in response to an action sent to the user by campaign controller 250. In some embodiments, campaign controller 250 may modify an existing template during an AIDA campaign based on a user's actions in response to an action sent to the user by campaign controller 250. In some embodiments, campaign controller 250 may change the order of actions in the template based on a user's actions in response to an action sent to the user by campaign controller 250. In some embodiments campaign controller 250 may change the content of messages described by the template detail pages and to be sent to a user, based on a user's actions in response to an action sent to the user by campaign controller 250. In some embodiments campaign controller 250 may change the timing of messages sent to a user based on a user's actions in response to an action sent to the user by campaign controller 250. In some embodiments, serving module 230 performs these functions on behalf of campaign controller 250. In some embodiments, campaign controller 250 makes determinations based on a user's actions in response to an action sent to the user by campaign controller 250 in addition to other information that the system knows or can obtain about the user.

In some embodiments, when a recipient in a campaign responds to a message of the campaign, campaign controller 250 sends the recipient's response to serving module 230. In some embodiments, the recipient's response is capture as a string. In some embodiments, serving module 230 receives the recipient's response as a string and parses the string into individual words and runs the individual words into a model in order to determine an appropriate response that will encourage the recipient to interact with a link in a message that was sent to them. In some embodiments, serving module 230 sends the string received from campaign controller 250 along with a metagraph containing a set of steps to process the string to a model. In some embodiments, serving module 230 executes the metagraph using a TensorFlow SDK. In some embodiments, the metagraph is stored in metagraph storage 361. The SDK is a set of APIs and the order in which serving module 230 calls the APIs determines the program or order of actions to be executed. In some embodiments, serving module 230 parses the string into individual words and from the words creates vectors into a vocabulary array. In some embodiments, a vocabulary array comprises a multidimensional array containing words. In some embodiments, the vocabulary array is created using unique words sourced from the questions and answers that were used to train the model.

In some embodiments, serving module 230 passes an integer for every word of the string received from campaign controller 250 to the model. In some embodiments, serving module 230 sends a stop code after sending one or more integers to the model. In some embodiments, in response to receiving the inputs from serving module 230, the model returns to serving module 230 a series of integers. In some embodiments, serving module 230 translates the integers received from the model back into words using the vocabulary array. In some embodiments, serving module 230 reconstructs a string from the words from the vocabulary array corresponding to the integers, and sends the string to campaign controller 250. In some embodiments, campaign controller 250 uses this string to create a message to a campaign recipient.

In some embodiments, an appropriate response generated by serving module 230 may include another copy of the link that was in a previous message. In some embodiments, an appropriate response generated by serving module 230 may include a new link for the user to interact with. In some embodiments, serving module 230 generates an appropriate response to the campaign recipient according to a model selected for the campaign recipient for the current campaign.

In some embodiments, campaign controller 250 includes a model retraining module 232 or model retrainer. The model retraining module 232 periodically retrains one or more artificial intelligence models 216. The model retraining module 232 may initiate retraining for a model after the model has been used a number of times and there is history on how effective the model has been. The model retraining module 232 may initiate retraining for a model because new information pertaining to the model has been acquired by AIDA system 215. The model retraining module 232 may initiate retraining for a model once it has received and stored sufficient recipient feedback to the model from AIDA campaigns. Once the model training module 232 has created a new version of a model, the new version of the model is stored in the appropriate model storage 216. In some embodiments, testing such as A/B testing may be used in order to determine if one version of a model is more effective than a second version of the model.

In some embodiments, campaign controller 250 includes a storage for campaigns 201. In some embodiments, the data structure of the campaign information stored for each campaign in campaign storage 201 includes one or more of a campaign ID, an account ID, a campaign name, a date and time that the campaign is scheduled to start, a date and time that the campaign started, a date and time that the campaign ended, a group to add a user to if the user interacts with a link in a simulated phishing message, a number of delivered simulated phishing emails that were delivered for this campaign, a number of simulated phishing emails that bounced back, a number of simulated phishing emails that were opened, a number of simulated phishing emails that a recipient interacted with, a status of the campaign, a phish prone percentage, a time zone, a data and time that the campaign was created and/or updated, whether or not text and/or SMS messages are allowed for the campaign, and whether or not VOIP calls are allowed for the campaign. In some embodiments, campaign storage 201 is a relational database. In some embodiments, campaigns storage relational database 201 has a relationship with groups storage 286 and recipients storage 202, wherein the relationship links one or more recipients to a group, and one or more groups to a campaign. In some embodiments, when a new AIDA campaign is created by the security awareness system server 280, new campaign monitor 233 creates a record for the campaign in campaigns storage 201 when the campaign is created, based on information provided in the company administrator console 295. Records in campaigns storage 201 are associated with accounts from accounts storage 284 which contains information about the company the campaign is associated with, for example the industry that the company is in. In some embodiments, the new campaign monitor 233 detects that a new campaign has been created by looking for records in campaign storage 201 where one of the created at date and time, the start date and time, and the scheduled at data and time of the record is in the past and where the end date and time of the record is not indicated and/or is in the future. In some embodiments, new campaign monitor 233 detects that a new campaign is running or executing by checking whether or not a corresponding process or a new process is executing or running in memory. In some embodiments, when campaign controller 250 detects a new campaign record in campaigns storage 201, campaign controller 250 updates the campaign record in campaigns storage 201 with the actual campaign start time, and creates one or more records in campaign recipients storage 202, for each user that is a recipient for the campaign. In some embodiments, the recipients comprise users that are selected for the campaign by the company administrator in the company administrator console 295. In some embodiments, the recipients comprise users that are members of groups selected for the campaign by the company administrator in the company administrator console 295. The user record created in campaign recipients storage 202 is associated with the campaign record in campaigns storage 201 for the campaign. In some embodiments, information about a user that is a recipient for a campaign is extracted from users storage 285 when the user record is created in campaign recipients storage 202, for example a user's email address and mobile phone number, what account the user is on, and what campaign the user is in. In some embodiments, information about a user is uploaded by a company administrator when the user record is created in campaign recipients storage 202. In some embodiments, information about a user is created based on a synchronization process with the account active directory 290 or using the LDAP service 289 to access an account directory. In some embodiments, information about a user is created or obtained from an active directory service 290 or via an LDAP service 289, or otherwise using LDAP to communicate with an active directory.

In some embodiments, the campaign controller 250 includes continuously block 231. The continuously block may include any type and form of executable instructions performing the functions and operations described herein. In some embodiments, the continuously block is a component or module of the campaign controller. In some embodiments, the continuously block is a set of functions, operations and instructions of the campaign controller. In some embodiments, the continuously block is a logical and executable construct for performing a set of functions. As with some or all of the other components of the AIDA system 215, multiple instances of continuously block 231 may be instantiated simultaneously for scalability and redundancy. In some embodiments, for each active AIDA campaign, continuously block 231 dynamically creates a list of campaign recipients that have not interacted with a link (e.g., all the users that are still actively in campaigns, since once a user clicks on a link the campaign ends for that user) based on the time of the last action for the recipient. In some embodiments, continuously block 231 dynamically creates this list by running a SQL query that joins to campaigns storage 201, to campaign recipients storage 202, and to campaign recipient actions storage 220. In some embodiments, continuously block 231 retrieves a number of records from the dynamically created list of campaign recipients and checks the number of records to determine if AIDA system 215 should perform an action for a recipient. In some embodiments, continuously block 231 continues to retrieve a number of recipient records to check to see if the recipients should have an action performed for them. If the recipient needs an action to be performed, campaign controller 250 puts an action message into action queue 266 to perform the action for the recipient, and the recipient's action table 220 is updated with a new record for the action that has been put into the action queue 266. If all recipient actions have been performed and all recipient records have been checked, in some implementations continuously block 231 will sleep for a period of time and then restart checking recipient records. In some embodiments, action queue 266 is an Amazon Simple Queue Service (SQS) queue.

In some embodiments, continuously block 231 may use a state machine to determine if it is time to send a recipient an action. If a state machine is used to track the state of each recipient, the state machine is updated when campaign controller 250 puts the action for the recipient into action queue 266. In some embodiments, the recipient moves from one step in a template to a next step in a template when an action is put into action queue 266 for the recipient. In some embodiments, the recipient moves from one step in a template to a next step in a template when an action is performed on a recipient. In some embodiments, when an action is put into action queue 266 for a recipient, the action is written into campaign recipient action storage 220 as a new record. In some embodiments, when an action is performed on a recipient, the action is written into the campaign recipient action storage 220 as a new record.

In some embodiments, continuously block 231 examines campaign storage 201 to find all actively running campaigns, and then examines campaign recipients storage 202 for all recipients in actively running campaigns. In some embodiments, continuously block 231 looks at the date and time the recipient was last processed for needed actions (LastCheckedAt). In some embodiments, recipients are retrieved by continuously block 231 for processing based on their LastCheckedAt data and time, with the recipients with the oldest LastCheckedAt date and time being retrieved first. In some embodiments, when continuously block 231 retrieves the record of a recipient in an actively running campaign to be reviewed, that recipient's campaign recipient record is marked so that no other continuously block 231 will retrieve the same recipient's record.

In some embodiments, after an action is performed for a recipient, there is a minimum amount of time that must pass before a next action is performed for this recipient. In some embodiments, the amount of time between when an action is performed for a recipient and when the next action is performed for a recipient may be bounded by a minimum value and a maximum value. For example, AIDA system 215 may be configured such that at least one hour and not more than two and a half hours must pass between consecutive actions performed for a recipient in an active campaign. In some embodiments, the amount of time between when an action is performed for a recipient and when the next action is performed for a recipient may be randomly chosen. In some embodiments, the amount of time between when an action is performed for a recipient and when the next action is performed for a recipient may be randomly chosen within the bounds of a minimum value and a maximum value.

In some embodiments, after an action is performed by campaign controller 250 for a recipient of an active campaign, the LastCheckedAt data and time is set to one hour past the time when the action is performed. For example, in some embodiments, if an action is performed by campaign controller 250 of a recipient of an active campaign on January 1^{st} at 7:00 a.m., the LastCheckedAt data and time is set to January 1^{st} at 8:00 a.m. In some embodiments, the LastCheckedAt data and time is stored in campaign recipients storage 202 in a record for the recipient. Continuously block 231 determines which recipients are due for a next action by looking for recipients, wherein the LastCheckedAt date and time in the recipient record in the campaign recipients storage 202 is older than the present time. When the LastCheckedAt date and time in the recipient record in campaign recipients storage 202 is older than the present time, then continuously block 231 checks when the last action was sent to the recipient. In some embodiments, continuously block 231 determines when the last action was sent to the recipient by sorting the records in the one or more campaign recipient actions table(s) in descending order in which they were created, and selecting the most recent record based on the time at which that record was created, which is the LastSentAction date and time. Continuously block 231 then generates a random number representing a duration of time. In some embodiments, the random number is less than a preset maximum value for the amount of time between when an action is performed for a recipient and when the next action is performed for a recipient. Continuously block 231 adds the random number representing a duration in time to the LastSentAction date and time. If the sum of the LastSentAction data and time plus the random number presenting a duration in time is older than the current time, then continuously block 231 determines that it is time for the recipient to be sent an action. In some embodiments, continuously block 231 checks the one or more campaign recipient actions table(s) in the campaign recipient actions storage 220 periodically to see if any recipient needs to be sent an action.

If it is time to send a recipient a next action, then in some embodiments, campaign controller 250 moves to the next step in that recipient's template to determine what action to perform for that recipient. In some embodiments, campaign controller 250 determines a next action to perform for that recipient based on one or more of the recipient's responses to a previous action. In some embodiments, after campaign controller 250 puts an action to be sent to the recipient into action queue 266, continuously block 231 updates the LastCheckedAt date and time for that recipient to the current time plus a minimum back-off time before a next action can be sent to the recipient. In some embodiments, after the message is successfully delivered to the recipient, continuously block 231 updates the LastCheckedAt date and time for that recipient to the current time plus a minimum back-off time before a next action can be sent to the recipient.

In some embodiments, campaign controller 250 may utilize the LastCheckedAt date and time field in the campaign recipient record for a recipient to cause the AIDA system to ignore the recipient for a period of time and not send the recipient any actions. In some embodiments, campaign controller 250 retrieves the business hours start and business hours end files from the accounts table for the account associated with the recipient. If the current time is outside of business hours, then in some embodiments continuously block 231 will set the LastCheckedAt date and time to the start of the next business day so that the user isn't looked at by campaign controller 250 until then. In some embodiments, campaign controller 250 determines statutory or mandatory holidays based on a location or region of the recipient or the account associated with the recipient, and continuously block 231 will set the LastCheckedAt date and time to the start of the next working day after the statutory or mandatory holiday. In some embodiments, campaign controller 250 determines that the current date and time falls on a weekend, and continuously block 231 then sets the LastCheckedAt date and time to be the start of the first day after the weekend. It can be seen how the campaign controller 250 can use the LastCheckedAt date and time to insert any desired back-off duration between actions of the campaign for a recipient.

In some embodiments, continuously block 231 uses business logic based on one of a recipient, an account associated with the recipient, an attribute associated with the recipient, an attribute associated with the account associated with the recipient, and other information pertaining to the recipient in order to determine which recipient records to examine such that continuously block 231 does not have to look at all recipients that are in active campaigns on each review. In some embodiments, artificial intelligence based timing models will be used to determine the best timing for a next action for a given recipient in a given campaign, rather than using a random back off period.

In some embodiments, campaign controller 250 includes storage for campaign recipients 202. In some embodiments, security awareness system server 280 accesses recipient records in campaign recipients storage 202 to determine all the users that are in an AIDA campaign. In some embodiments, campaign controller 250 can determine whether a user has been a recipient in an

AIDA campaign in the past by determining if a recipient record for the user exists in campaign recipients storage 202. Campaign controller 250 can determine which campaign or campaigns the user was a recipient for by reading the campaign ID in each of the recipient records for the user in campaign recipients storage 202. In some embodiments, the data structure of the campaign recipients information stored for each campaign recipient in campaign recipient storage 202 includes one or more of a recipient ID, a campaign ID, the recipients' user ID, the last time this recipient was processed for needed actions (LastSentAction date and time), an indication of the first next time that a recipient should be considered ready to receive a next campaign action (LastCheckedAt date and time), the recipient's email address, and the recipient's phone number. In some embodiments, if the user has not previously been part of an AIDA campaign, campaign controller 250 collects data including the attributes and features of the user from users storage 285. In some embodiments, the information that campaign controller 250 collects from users storage 285 includes a user's email address, a user's phone number, a user's mobile phone number, the account that the user is associated with (e.g. the company that the user is associated with), and other information that that can be accessed about the user from users storage 285. In some embodiments, if the user has not previously been part of an AIDA campaign, then campaign controller 250 collects data including the attributes and features of the account that the user is associated with from accounts storage 284. In some embodiments, the information that campaign controller 250 collects from accounts storage 284 includes the industry that the user's company is in, where the company is geographically located, the company's phish-prone percentage, and other information that can be access about the user's company from accounts storage 284. In some embodiments, campaign controller 250 collects and curates information about the user from one or more of the Internet, social media feeds, and reliable databases. In some embodiments, a unique record is created in campaign recipients storage 202 for a user for every different campaign and the unique record is associated with the campaign, such that there is more than one recipient record in campaign recipients storage 202 for a user.

In some embodiments, some of the data structure in campaign recipient storage 202 is filled in by one or more workers 260, such as when the recipient interacts with a simulated phishing message. A worker 260 may include any type and form of executable instructions performing the functions and operations described herein. In some embodiments, the worker is a component or module of the campaign controller. In some embodiments, the worker is a set of functions, operations and instructions of the campaign controller. In some embodiments, the worker is a logical and executable construct for performing a set of assigned functions. In some embodiments, a worker 260 will record the date and time when a recipient opened an email message. In some embodiments, a worker 260 will record a date and time when a recipient interacted with any of the links in an email or a text. In some embodiments, a worker 260 will record a date and time when an email was delivered to a recipient's email server. In some embodiments, a worker 260 will record a date and time when an email template has been processed and is waiting in the outgoing email queue 265. In some embodiments, a worker 260 will record a date and time when an email is sent to a recipient. In some embodiments, a worker 260 will record a data and time when all templates were delivered to this recipient. In some embodiments, the recipients' browser agent string, including one or more of a user agent, a platform, a browser, a browser version, and OS, and an IP address, will be recorded when the recipient clicks on a link in a simulated phishing message. In some embodiments, campaign recipients storage 202 is a relational database. In some embodiments, campaigns recipients storage relational database 202 has a relationship with campaign recipient actions storage 220a . . . 220n.

In some embodiments, campaign controller 250 includes a storage for template details 203. In some embodiments, the data structure of the template details information stored for each template detail record in template details storage 203 includes one or more of a template ID, settings for a service that describes the input one or more VoIP calls, settings for one or more text or SMS messages, settings for one or more email messages, and an ordinal field which contains the order of a collection of detail records for the template. In some embodiments, the data structure of the template details information stored for each template record in template details storage 203 includes a date and time that the record was created and/or updated. In some embodiments, a template detail record in template detail storage 203 can associate a template detail page to a landing domain.

In some embodiments, the settings for a service that describes the input for one or more VOIP calls include a script string. The script string may include the voice script to use for a VoIP call. In some embodiments, the settings for a service that describes the input for one or more VoIP calls includes a voice type to use to speak the script on a voice call. In some embodiments, the settings for a service that describes the input for one or more VoIP calls includes a language to use for a VoIP call. In some embodiments, the settings for a service that describes the input for one or more VoIP calls includes a counter which indicates the number of times to repeat the VoIP call voice script. In some embodiments, the settings for a service that describes the input for one or more VOIP calls includes a location of an audio file to be used for a VoIP call. In some embodiments, the audio file may be an MPEG-1 audio layer 3 (MP3) file, an MPEG-1 audio layer 4 (MP4) file, a pulse-code modulation (PCM) file, a waveform audio file format (WAV) file, an audio interchange file format (AIFF) file, an advanced audio coding (AAC) file, a windows media audio (WMA) file, a free lossless audio codec (FLAC) file, an Apple lossless audio codec (ALAC) file, a Window media audio (WMA) file, or any other audio file format. In some embodiments, the audio files that may be used as an input to one or more VOIP calls are stored in VoIP content storage 241. In some embodiments, a text to speech (TTS) engine 240 may be used to generate an audio file for one or more VoIP calls. In some embodiments, the text to be used by the TTS comes from serving module 230 of campaign controller 250.

In some embodiments, the settings for a service that describes the input for one or more SMS messages, text messages, or emails messages includes a string. The string may identify, contain or provide the body of the message. In some embodiments, the string comprises an identifier to file that has the body of the message. In some embodiments, the string comprises an identifier or key to a record or data in a database that has the body of the message In some embodiments, the string comprises an identifier to file that will be attached with the message. In some embodiments, the settings for a service that describes the input for one or more SMS messages, text messages, or emails messages includes a string which contains the subject of the message. In some embodiments, the settings for a service that describes the input for one or more SMS messages, text messages, or emails messages includes a string which indicates who or where the message is from. In some embodiments, the settings for a service that describes the input for one or more SMS messages, text messages, or emails messages includes a string which indicates a reply to address for the message. In some embodiments, the settings for a service that describes the input for one or more SMS messages, text messages, or emails messages includes a string which contains the name to display to indicate who or where the message is from. In some embodiments, the settings for a service that describes the input for one or more SMS messages, text messages, or emails messages includes a landing page ID which indicates the landing page to use for this message. In some embodiments, the settings for a service that describes the input for one or more SMS messages, text messages, or emails messages includes a landing domain ID which indicates the domain to use for a message. In some embodiments, the settings for a service that describes the input for one or more SMS messages, text messages, or emails messages includes a landing domain prefix or a landing domain suffix to add before the domain or at the end of a URL and before a slug. In some embodiments, the settings for a service that describes the input for one or more SMS messages, text messages, or emails messages includes a type which indicates whether the record is for an email, an SMS or text message, or a VoIP call.

In some embodiments, the service that provides SMS or text messages and VoIP calls is a cloud based communications platform as a service that enables communications between mobile devices, applications, services, and systems, such as by providing a globally available cloud API. An example of a cloud communications platform as a service that can be used to provide SMS or text messages and VoIP calls is Twilio of San Francisco, California. In some embodiments, workers 260 pass to a cloud communications platform one or more of a “call from” phone number, a recipient phone number to call to, and a URL to an audio file to be played on the call.

In some embodiments, campaign controller 250 includes a storage for templates 204. In some embodiments, the data structure of the template information stored for each template record in template storage 204 includes one or more of a template ID, a template name, a template category ID, an indicator of whether or not the template is archived, an indication of the level of sophistication of the template, and a date and time that the template was created and/or updated. In some embodiments, template storage 204 is a relational database. In some embodiments, template storage relational database 204 has a relationship with template details storage 203.

In some embodiments, campaign controller 250 includes a storage for “call from” phone numbers 205. In some embodiments, the data structure of the “call from” phone number information stored for “call from” phone number record in “call from” phone number storage 205 includes one or more of a phone number ID, an abbreviation for one of the state, the province, the region, the county, and the jurisdiction. In some embodiments, the data structure of the “call from” phone number information stored for “call from” phone number record in “call from” phone number storage 205 includes a city name that the phone number is associated with. In some embodiments, the data structure of the “call from” phone number information stored for “call from” phone number record in “call from” phone number storage 205 includes a country code associated with the phone number. In some embodiments, the data structure of the “call from” phone number information stored for “call from” phone number record in “call from” phone number storage 205 includes an area code associated with the phone number. In some embodiments, the data structure of the “call from” phone number information stored for “call from” phone number record in “call from” phone number storage 205 includes a list of other phone number area codes in the same area as the phone number. In some embodiments, the data structure of the “call from” phone number information stored for “call from” phone number record in “call from” phone number storage 205 includes the digits of the phone number. In some embodiments, the data structure of the “call from” phone number information stored for “call from” phone number record in “call from” phone number storage 205 includes an indication of whether or not the phone number can be used in an AIDA campaign. In some embodiments, the data structure of the “call from” phone number information stored for “call from” phone number record in “call from” phone number storage 205 includes an indication of whether or not the phone number can send or receive text messages. In some embodiments, the data structure of the “call from” phone number information stored for “call from” phone number record in “call from” phone number storage 205 includes an indication of whether or not the phone number can be used to send or receive VoIP calls. In some embodiments, the data structure of the “call from” phone number information stored for “call from” phone number record in “call from” phone number storage 205 includes an indication of whether the phone number is an international number. In some embodiments, the data structure of the “call from” phone number information stored for “call from” phone number record in “call from” phone number storage 205 includes a date and time that the record was created and/or updated at. In some embodiments, the AIDA system 215 chooses a “call from” number to send a message to a recipient such that the area code of the “call from” number is the same as the area code of the recipient's phone number.

In some embodiments, campaign controller 250 includes a storage for campaign groups 206. In some embodiments, the data structure of the campaign groups information stored for each campaign group record in campaign groups storage 206 includes one or more of a campaign ID and a group ID. In some embodiments, a record in campaign group storage 206 is used to associate campaign records with group records. In some embodiments, when campaign controller 250 creates a campaign, campaign controller 250 selects one or more groups that the campaign will be sent to, which establishes a relationship between the campaign and one or more groups in groups storage 286. In some embodiments, groups in groups storage 286 are already established and are linked to accounts. In some embodiments, one account may have multiple established groups which are stored in groups storage 286. In one embodiment, groups in campaign groups storage 206, together with memberships storage 287 and groups storage 287 are linked together through relational databases to establish which groups are part of an AIDA campaign, and to establish which users are part of those groups. Groups in campaign groups storage 206 are linked to a campaign ID, to a group ID, and then groups storage 286 links users to groups based on memberships storage 287 which may be a relational database.

In some embodiments, campaign controller 250 includes storage tagging 207 and storage for tags 208. In some embodiments, the data structure of the tagging information stored for each tagging record in tagging storage 207 includes one or more of a record ID, a tag ID, a taggable ID, a taggable type, a tagger ID, a tagger type, a context, and a date and time that the record was created and/or updated. In some embodiments, taggings are used to categorize templates. In some embodiments, taggings in taggings storage 207 indicate an association between a tag from tag storage 208 and a template from template storage 204. The tags and/or tagging may be any type and form of data, identifier, string, etc. to help identify, group, associate or classify certain elements or data, such as by attributes, categories, users and the like. In some embodiments tags are used to categorize templates and may be used to group templates, such as based off a model output or by customer. In some embodiments, the data structure of the tags information stored for each tags record in tags storage 208 includes one or more of a record ID, a tag name, and a taggings count. One example of a tag is “fraud reporting”. In one embodiment, there may be one or more templates related to fraud reporting, and the one of more templates related to fraud reporting are all assigned the same fraud reporting tag. Another example of a tag is “appointment reminders”.

In some embodiments, campaign controller 250 includes, stores and/or manages one or more campaign recipient actions table(s) in one or more campaign recipient actions storages 220a . . . 220n (220). In some embodiments, the data structure of the actions information stored for each record in the one or more campaign recipient actions table(s) includes one or more of a record ID, a recipient ID, a template ID, a template detail ID, a template ordinal, a type of action, a landing domain ID, and landing page ID, a landing domain, and attachment type, an attachment filename, a sophistication level, a “reply to” address, a “from” display name, a subject, an email system message ID, and email system queue ID, one or more failure codes and one or more error messages, information about the recipient's browser and user agent if the user clicks on a phish URL, a scheduled at date and time, a created at date and time, and an updated at date and time. In some embodiments, when a template is chosen for an AIDA campaign for a given user, the association of the template with the user for the specific AIDA campaign in stored in the campaign recipients actions table in the template ID field. In some embodiments, the one or more campaign recipient actions table(s) store(s) actions for multiple users/recipients. In some embodiments, the template and where the campaign recipient is in that template is a state that is saved by campaign controller 250 in the one or more campaign recipient actions table(s). When a message gets sent to a campaign recipient, that action gets recorded in a record in the one or more campaign recipient actions table(s). That record in the one or more campaign recipient actions table(s) is later used by campaign controller 250 to know that a step in the template has occurred and the campaign should proceed to the next step in the template.

In some embodiments, the campaign controller 250 queries, interfaces or uses records and/or data of the one or more campaign recipient actions table(s) to determine next action(s) to perform or take. For example, when it is time for campaign controller 250 to perform the next action for a given recipient, campaign controller 250 looks in the one or more campaign recipient actions table(s) to determine what the last action was, and then either looks in the template to determine what the next step is, or determines what the next step is using an AI model, and then campaign controller 250 sends a message to action queue 266 to trigger the next action for the campaign recipient. In some embodiments, the message that campaign controller 250 puts into action queue 266 contains one or more of a recipient ID, a template ID, and a detail ID, which is the ordinal value within the template, which refers to which detail page to use. In some embodiments, campaign controller 250 reads the detail ID from the record of the last action for the recipient, stored in the one or more campaign recipient actions table(s), in order to determine what step of the template the recipient is currently on. In some embodiments, the message that campaign controller 250 puts into action queue 266 includes the type of the message to be sent to the recipient, wherein the type is one of an email, an SMS or text message, and VoIP call, or and Internet based communication. In some embodiments, the type of the message to be sent to the recipient is determined based on the template.

In some embodiments, the type of action is one of email, text, call, email delivered, email delivery failed, opened, email clicked, text clicked, reporting using a user interface, error sending text, and error making VoIP call. In some embodiments, when a user clicks the phish URL, one of more of the following information is stored in the action record: user agent, platform, browser, browser version, operating system, whether or not the user is using a mobile device, whether or not the user is a bot, and an IP address.

In some embodiments, campaign controller 250 creates, manages and/or processes records and/or data in campaign recipient actions storage 220. In some embodiments, when campaign controller 250 performs an action on a campaign recipient, campaign controller 250 checks to see if there exists one or more records for that recipient in the one or more campaign recipient actions table(s) in campaign recipient actions storage 220 t. In some embodiments, if no record exists, then this means that this is a new recipient that has not participated in an AIDA campaign before, and campaign controller 250 creates a new campaign recipient actions table for this recipient, and/or creates a record in the one or more campaign recipient actions table(s) for the action that was performed on this recipient.

In some embodiments, one or more records in the one or more campaign recipient actions table(s) 220 identifies or tracks whether a campaign recipient has been part of an AIDA campaign. In some embodiments, if one or more campaign recipient actions table(s) 220 with one or more records for a campaign recipient exists, then the recipient has been in an AIDA campaign previously. In some embodiments, campaign controller 250 extracts information for that recipient from the one or more campaign recipient actions table(s) 220 in addition to extracting user attributes from users storage 285 and company attributes from accounts storage 284, and campaign controller 250 passes this information to serving module 230.

In some embodiments, campaign controller 250 maintains records of any activity, events, issues, errors, user interactions, user actions, lack of user interactions, etc. (generally referred to activity or events) that have happened to, occurred with, caused by or associated with a given user in all previous AIDA campaigns in the one or more campaign recipient actions table(s) stored in campaign recipient actions storage 220. In some embodiments, both actions and the result of actions get stored in one or more campaign recipient actions table(s). In some embodiments, any data associated with the activity or events is stored, such as but not limited to, data about the computing device, the user, user input, any applications, programs or tasks running on the computing device. In some embodiments, if the phone number for the user was incorrect, this information gets stored in the one or more campaign recipient actions table(s). In some embodiments, if the user opens an email, this information gets stored in the one or more campaign recipient actions table(s). In some embodiments, if the user clicks on a link in a message, this information gets stored in the one or more campaign recipient actions table(s). In some embodiments, the amount of time between sending an action to a recipient and the recipient's response to the action gets stored in the one or more campaign recipient actions table(s). In some embodiments, campaign controller 250 additionally maintains records of all non-AIDA campaigns and/or training programs that the user has completed or been exposed to in the one or more campaign recipient actions table(s) stored in campaign recipient actions storage 220. In some embodiments, one or more of campaign controller 250, serving module 230, workers 260, email workers 261, website workers 264, and security awareness system server 280 can access campaign recipient actions table(s) storage 220.

In some embodiments, while one or more AIDA campaigns are running, campaign controller 250 collects information for all users that are recipients in an AIDA campaign and the information gets stored in the one or more campaign recipient actions table(s), in one or more campaign recipient actions storages 220a . . . 220n. For every campaign, there is a unique user recipient record in campaign recipients storage 202 that is linked to each new action performed on that user for the campaign. In some embodiments, there are multiple campaign recipient action records in the one or more campaign recipient actions table(s). In some embodiments, records in the one or more campaign recipient actions table(s) are linked to a single record in campaign recipients storage 202. In some embodiments, when a user gets added to a new AIDA campaign, a new campaign recipient record in campaign recipient storage 202 will be created for the user that is only linked to the new AIDA campaign. In some embodiments, if the user has already been in an AIDA campaign, and therefore the user already has a one or more records in one or more campaign recipient actions table(s), the entries of the actions for a new AIDA campaign get stored in new records in the one or more campaign recipient actions table(s), and the new records are linked to the new campaign recipient record in campaign recipient storage 202, which is linked to the new AIDA campaign which is stored in a record in campaigns storage 201.

In some embodiments, the one or more campaign recipient actions table(s) are stored in campaign recipient actions storage 220. In some embodiments, the one or more campaign recipient actions table(s) are persistent and maintained indefinitely or until a predetermined time period. In some embodiments, the one or more campaign recipient actions table(s) is/are stored forever and does not get deleted. In some embodiments, the one or more campaign recipient actions table(s) are retroactive and only contain actions from that past that have happened, and not actions that will happen in the future. In some embodiments, user actions that are stored in one or more campaign recipient actions table(s) are also reported on the company administrator console 295 so that the company administrator know what happened. In some embodiments, the data within the one or more campaign recipient actions table(s) can be used by dashboard generator 298 in company administrator console 295 to generate reports and visual data displays.

In some embodiments, campaign controller 250 includes one or more workers 260. In some embodiments, workers 260 receive messages from actions queue 266 and perform the actions that the messages describe. In some embodiments, when workers 260 receive a message from actions queue 266, if the action described in the message is to send an email to a recipient, then workers 260 put the message directly into incoming email queue 264 for one or more email workers 261 to pick up and process.

In some embodiments, when workers 260 receive a message from the action queue 266, workers 260 do the task of building the message. In some embodiments, email workers 261 use the information in the message to fetch the detail page of the indicated template from email database 262, and using user specific information from users storage 285, email workers 261 will populate the detail page with the user specific information, and then email workers 261 will put the full composed email into cloud storage, and put the headers of the email into outgoing email queue 265, which sends emails via two or more mail servers. In some embodiments, the cloud storage is an S3 bucket provided by Amazon Simple Storage Service (Amazon S3). In some embodiments, outgoing email queue 265 is an Amazon Simple Queue Service (SQS) queue. In some embodiments, for scaling and redundancy, there are multiple workers 260, and the queue service (for example, Amazon SQS) posts the message from action queue 266 to an available worker 260. In some embodiments, the queue service spreads messages from actions queue 266 evenly across multiple workers 260.

In some embodiments, workers 260 determine the recipient of the message, and look up the recipient in campaign recipient storage 202 to determine the campaign the recipient is in, then workers 260 look up the campaign in campaigns storage 201, and then workers 260 look up the one or more records in the one or more campaign recipient actions table(s) for the recipient to determine the template to use, and then workers 260 look up the detail page of the template using the detail ID.

In some embodiments, if the detail page of the template is a text message, the worker retrieves the data required to send the test message to the recipient, for example the recipients mobile phone number, from users storage 285, and then workers 260 build the text message and send it through the Twilio service. In some embodiments, if the detail page of the template is an email, then workers 260 forward the message exactly as they received it to incoming email queue 264 for email workers 261 so that they can build the email message for the recipient. In some embodiments, workers 260 have a template fetcher which builds the message, retrieving user specific information that is built into the email message and incorporated into the detail page of the template.

In some embodiments, campaign controller 250 includes one or more email workers 261. In some embodiments, email workers 261 generate email messages. In some embodiments, email workers 261 interface with two queues; incoming email queue 264 and outgoing email queue 265. In some embodiments, incoming email queue 264 indicates that it is time to send an email message. The message to do this action come to email workers 261 from campaign controller 250 via workers 260. In some embodiments, the message to generate an email message contains the recipient ID, the template ID, and the detail ID. In some embodiments, email workers 261 compose the email, put the email body and the email headers together, and put the completed email address in outgoing email queue 265 until it gets processed. In some embodiments, email workers 261 only put the email header in outgoing email queue 265 until it gets processed. In some embodiments, once the email gets sent, campaign controller 250 updates the one or more campaign recipient actions table(s) to reflect that the AIDA system delivered the email to the recipient, and the email header is removed from the outgoing email queue 265. In some embodiments, email workers 261 have an email database 262 which contains a queue table, message headers, and a transient table where the state is stored.

In some embodiments, campaign controller 250 includes one or more website workers 263. In some embodiments, when a recipient opens an email, clicks on a link in an email or a text message, or otherwise interacts with the action sent to them, website worker 263 serves up the landing page from landing page storage 283 to the recipient. In some embodiments, website workers 263 present the recipient with any training that they must complete at the moment of failure. In some embodiments, when a recipient fails a simulated phishing test, website workers 263 enroll the user in remedial training that will take place at some time in the future.

In some embodiments, website workers 263 track one or more of the following information: which recipients interacted with a link, what browsers the recipients were using when they interacted with a link, what the recipient's user agent was when they interacted with a link. In some embodiments, website workers 263 record the recipient's actions in the one or more campaign recipient actions table(s). In some embodiments, when campaign controller 250 wants to send a VoIP message, worker 260 that receives that message from action queue 266 and asks website worker 263 what message to send. In some embodiments, anything that the AIDA system 215 tracks and any actions taken by the recipients are automatically sent to website workers 263. In some embodiments, if a recipient replies to a text message, the recipients response is stored by website workers 263. In some embodiments, if a user replies to an AIDA simulated phishing message, their reply gets delivered to a special email address that is connected to an AWS Simple Notification Service (SNS). In some embodiments, the SNS sends this reply email to an AWS Lambda endpoint (AWS Lambda) which stores the reply email in an S3 bucket. When the reply email gets stored in the S3 bucket, security awareness system server 280 gets notified that there is a new email reply which creates a record in the one or more campaign recipient actions table(s) which is/are monitored by campaign controller 250.

In some embodiments, landing pages are served to a recipient by website workers 263 when a user interacts with a link in a message. In some embodiments, all the information about the recipient comes back to campaign controller 250 through the URL that the recipient interacted with, as this URL is created specifically for each recipient and it has at least the recipient ID and the detail ID in it. In some embodiments, the information in the URL is encrypted.

### D. Artificial Intelligence Models

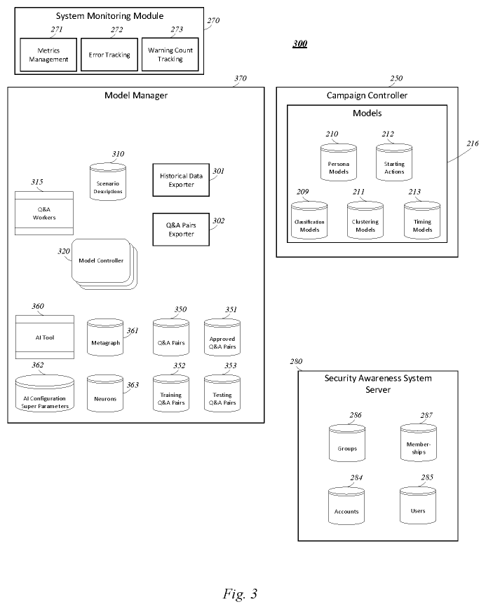

Referring to FIG. 3 in a general overview, FIG. 3 depicts an embodiment of a system 300 used for creating, updating, and managing models, such as artificial intelligence or machine learning models, for use in AIDA simulated phishing campaigns. System 300 includes campaign controller 250, security awareness system server 280, system monitoring module 270, and model manager 370. Artificial intelligence refers to computer systems which exhibit intelligent behavior, including the capacity to learn, maintain a large storehouse of knowledge, use reasoning, apply analytic abilities, discern relationships between facts, communicate ideas to others and understand communications from others, and perceive and make sense of the situation. Machine learning systems create new knowledge by finding previously unknown patterns in data, driving solutions by learning patterns in data.

Neural networks are computer systems designed, constructed and configured to simulate the human nervous system. The neural network architecture consists of an input layer, which inputs data to the network; an output layer, which produces the resulting guess from the network; and a series of one or more hidden layers, which assist in propagating. Such systems learn to do tasks or make decisions by considering examples. A neural network or artificial neural network is based on a collection of connected units called neurons or artificial neurons. Each connection (synapse) between neurons can transmit a signal to another neuron. The receiving (postsynaptic) neuron can process the signal(s) and then signal downstream neurons connected to the neuron. Neurons may have state, generally represented by real numbers, typically between 0 and 1. Neurons and synapses may also have a weight that varies as learning proceeds, which can increase or decrease the strength of the signal that it sends downstream. Further, neuron may have a threshold such that only if the aggregate signal is below (or above) that level is the downstream signal sent. Typically, neurons are organized in layers. Different layers may perform different kinds of transformations on their inputs. Signals travel from the first (input), to the last (output) layer, possibly after traversing the layers multiple times. In artificial networks with multiple hidden layers, the initial layers might detect primitives (e.g. the pupil in an eye, the iris, eyelashes, etc.) and their output is fed forward to deeper layers who perform more abstract generalizations (e.g. eye, mouth) . . . and so on until the final layers perform the complex object recognition (e.g. face).

Neural networks are trained with data, such as a series of data points. The networks guess which response should be given, and the guess is compared against the correct of “best” guess for each data point. If errors occur, the neurons are adjusted, and the process repeats itself. Training a neural network model corresponds to selecting one model from the set of allowed models. A model may be established by selection of a neural network configured, programed or trained in a certain way with certain data.

In the context of the AIDA system, neural networks may be trained with data related to simulated phishing campaigns to create or establish models that direct, identify or specify how to configure and/or execute a simulate phishing campaign. As such, the training of neural networks applies machine learning to data from and associated with results of simulated phishing campaigns to establish models for simulated phishing campaigns. A model for a simulated phishing campaign may take as input any type and form of information related to the simulated phishing campaign, such as but not limited to attributes of user, attributes of the company of the users, date and temporal information, previous actions, user history, template information, previous types of messages communicated, timing information, etc. The model may output any information for creating, executing and/or managing a simulated phishing campaign, such as but not limited to a first action to perform, a next action to perform, a persona to use, a template to use, content of the template, type of message/communication, timings of message/communications, etc.

The AIDA system 215 uses information related to simulated phishing communications and campaigns to develop, establish and or train models. In some embodiments, the AIDA system uses question and answer pairs and/or information learned from past simulated phishing campaigns to create models which are able to target the greatest vulnerabilities of a user. In some embodiments, AIDA system 215 can combine redacted information across multiple companies (accounts) and determine the greatest vulnerability of a specific industry, or a specific geographic region, or of a specific population demographic, or of a specific organizational level, as examples.

One type of artificial intelligence or machine learning model used by AIDA system 215 is a persona model. In one embodiment, persona models are stored in persona models storage, 210. A persona model is a persona that AIDA system 215 uses to communicate with users. The persona model may be a model configured, established or trained to represent a certain type or category of person. The persona model may be a model configured, established or trained to represent a certain type of persona or personality. The persona model may be a model configured, established or trained to represent a certain type or category of job, occupation or role. In some embodiments, a persona model is a dental office assistant. In some embodiments, a persona model is a travel agent. In some embodiments, a personal model is a credit card company. In some embodiments, a persona model is a technical support representative. In some embodiments, a persona model is a technical support representative for Facebook, created by Facebook, Inc. of Menlo Park, California.

In one embodiment, models are created by model controller or manager 320. In a general overview, model manager 370 includes storages for question and answer pairs (Q&A pairs) 350, storage for question and answer pairs used for training (training Q&A pairs) 352, storage for questions and answer pairs that are used for testing (testing Q&A pairs) 353, and storage for question and answer pairs that are approved (approved Q&A pairs) 351. In some embodiments, model manager 370 includes historical data exporter 301, and Q&A pairs exporter 302. In some embodiments, model manager 370 includes model controller 320, Q&A workers 315, and AI tool 360. Model manager 370 may include storages for scenario descriptions 310, storages for metagraph 361, storages for neurons 363, and storages for AI configuration super parameters 362.

In some embodiments, model manager 370 includes worker interface 314. The worker interface may comprise any type and form of executable instructions, such as an application, program, service, process, task or API, executable one or more processors, for interfacing and/or communications with one or more workers. The worker interface may be designed, constructed and/or configured to prompt, query, ask or request information, input or to work on a task from one or more workers. For example, the worker interface may include or provide a user interface that provides information on a queue, a task and/or status of a task. The worker interface may be designed, constructed and/or configured to receive and/or obtains information from one or more workers. For example, the worker interface may include or provide a user interface that receives information from a work, such as input, or results from or status of a task. In some implementations, the work interface is designed, constructed and/or configured to interface and/or communicate with a user, such as a user performing a task of as worker. In some implementations, the work interface is designed, constructed and/or configured to interface and/or communicate with a system, application, program, etc., that is to perform one or more tasks. For example, in some embodiments, Q&A workers 315 may be a model, or may be an automated software agent. In some embodiments, worker interface 314 is a model, a program, a function, a module, an automated software agent or software instructions operating on one or more processors that interfaces with one or more person., In some embodiments, worker interface 314 organizes task queues, job queues, tasks and/or jobs. In some embodiments, worker interface 314 passes information to Q&A workers 315 and/or receives information from Q&A workers 315. Worker interface 315 may invite, un-invite, select, or deselect Q&A workers 315.

In one embodiment, models are created by creating question and answer pairs. In some embodiments, a service such as Amazon Mechanical Turk (MTurk) is used to create question and answer pairs. In some embodiments, questions are recipient responses to messages sent to a recipient by AIDA system 215, and answers are the recipients responses to AIDA system messages. In some embodiments, the question and answer pairs are stored in Q&A pairs storage 350. In some embodiments, only the question and answer pairs that have not yet been validated are stored in Q&A pairs storage 350. In some embodiments, the question and answer pairs are validated by Q&A workers 315 and then stored in approved Q&A pairs storage 351. In some embodiments, validated Q&A pairs in approved Q&A pairs storage 351 are divided into two or more groups of Q&A pairs. In some embodiments, one or more group of Q&A pairs is used for training models and is stored in training Q&A pairs storage 352. In some embodiments, one or more group of Q&A pairs is used for testing models and is stored in testing Q&A pairs storage 353.

In some embodiments, Q&A workers 315 are MTurk workers. In some embodiments, a model is trained by feeding it a number of approved questions which represent example AIDA system messages that a specific model could send to a recipient, along with a number of approved answers which represent appropriate responses to the approved questions.

In some embodiments, model controller 320 creates jobs for Q&A workers 315 to develop Q&A pairs. In some embodiments, the job requests give an example of the messages that campaign controller 250 sends to a user, in addition to examples of good Q&A pairs. In some embodiments, model controller 320 additionally gives Q&A workers 315 examples of poor Q&A pairs. In some embodiments, while model controller 320 is utilizing Q&A workers 315 to create Q&A pairs, system monitoring module 270 maintains a dashboard of all the jobs being performed by Q&A workers 315.

In some embodiments, a first task given to Q&A workers 315 by model controller 320 is to create Q&A pairs, comprising user responses to an AIDA system message (questions) and the AIDA system responses to the user responses (answers). In some embodiments, Q&A workers 315 are given a scenario description from scenario descriptions storage 310, which includes the original AIDA system message or messages, and Q&A workers 315 are first asked to create replies or questions that the recipient may ask the AIDA system, and then Q&A workers 315 are asked to create an appropriate answer that the system could respond to the recipients replies or questions with. In some embodiments, model controller 320 informs Q&A workers 315 that the generated recipient responses (the questions) should be representative of the way a user would respond if they received the AIDA system message that was detailed in the scenario description.

In some embodiments, model controller 320 informs Q&A workers 315 to create system replies to recipient responses (answers) that will encourage the recipient to interact with a link in a simulated phishing message. In some embodiments, model controller 320 informs Q&A workers 315 to apply criteria to creating the system responses (answers) that are created for the recipient responses (questions). In some embodiments, model controller 320 informs Q&A workers 315 to use proper grammar and spelling in the system responses (answers). In some embodiments, model controller 320 informs Q&A workers 315 to not use slang in the system responses (answers). In some embodiments, model controller 320 informs Q&A workers 315 that the recipient responses to the AIDA system messages (the questions) may incorporate slang, spelling mistakes, profanities, typical shorthand, and urban grammar.

In one embodiment, a sample AIDA system email message provided by model controller 320 to Q&A workers 315 is:
This email is to confirm a password reset was just requested for your account. If you did not request this, please visit the following link: http://secure.social-tech.com/accounts/password-reset-request/?uuid=9431edpoks&language=en&reset=reject
Otherwise you will be locked out of your SocialTech account.
Thank you,
SocialTech.

In one embodiment, an example of an AIDA system SMS or text message provided by model controller 320 to Q&A workers 315 is:
A password change was requested. We want to verify this is you. If you did not request a password change please click this link http://bit.ly/2hXJZd6 or you will be locked out of your SocialTech account.

In some embodiments, the task given to Q&A workers 315 by model controller 320 is to create Q&A pairs, where all the questions and answers are to be different. In one embodiment, an example of acceptable question and answer pairs are as follows:
Question 1: I don't have a SocialTech account
Answer 1: Sorry, but someone requested a password reset on your account. Please click the link to verify or dispute this.
Question 2: When will I get locked out?
Answer 2: You have 8 hours to click the link to verify or dispute the password reset, after which you will be locked out of your Social Tech account.

In some embodiments, the goal of the system response (answer) to the recipient response (question) is to get the recipient to interact with or click on a link, therefore answers to questions which do not move the user towards this action are not acceptable. In one example, if the system response (answer) created by Q&A worker 315 is that the recipient should “Call customer service”, this response would not encourage the recipient to click on a link and therefore would not be acceptable. Similarly, system responses (answers) that are phrased in a way which would elicit further recipient responses (questions) or would encourage the recipient to disregard the system message are not acceptable.

In some embodiments, once Q&A workers 315 have created Q&A pairs which may be stored in Q&A pairs storage 350, Q&A workers 315 are asked to review and validate the created Q&A pairs to see if they are acceptable. In some embodiments, Q&A worker 315 responds to the appropriateness of the questions and the answers with a binary reply, for example one of yes if the question or answer is acceptable and zero or no if the question or answer is not acceptable. In some embodiments, each Q&A pair is reviewed by more than Q&A worker 315. In some embodiments, the Q&A pairs are only considered approved if all of the Q&A workers 315 that review the Q&A pairs deem the questions and the answers to be acceptable. In some embodiments, the Q&A pairs that are considered approved are stored in approved Q&A pairs storage 351. In some embodiments, the Q&A pairs are considered approved by one or more or all of the Q&A workers 315 that reviewed the Q&A pairs are further reviewed by a trusted person before being stored in approved Q&A pairs storage 351.

In some embodiments, model manager 370 includes Q&A pairs exporter 302. In some embodiments, Q&A pairs exporter 302 extracts question and answer pairs from approved Q&A pairs storage 351 and creates intermediate files. In some embodiments, the one or more intermediate files are used for the input into a data prep program which separates the Q&A pairs into two groups. In some embodiments, one group is used for initialization and/or training of a neural network for a model, and one group is used for testing the neural network for the model. The Q&A pairs in the first group are stored in training Q&A pairs storage 352, and the Q&A pairs in the second group are stored in testing Q&A pairs storage 353. In some embodiments, training Q&A pairs storage 352 and testing Q&A pairs storage 353 are MySQL databases which are hosted on Amazon AWS RDS.

In some embodiments, the Q&A pairs generation and validation process is done for every model that is generated. In some embodiments, the Q&A pairs generation and validation process is fully automated. In some embodiments, some portions of the Q&A pairs generation and validation process are automated. In some embodiments, responses given by recipients in AIDA campaigns are used as questions for the Q&A pairs generation and validation process.

In some embodiments, the models created by model manager 370 are stored in model storage 216. In some embodiments, model storage 216 is part of campaign controller 250. In some embodiments, model storage 216 is part of model manager 370. In some embodiments, model storage 216 is stored in memory 122 as part of AIDA system 215. In some embodiments, model storage 216 is stored in a cloud storage, for example an S3 bucket.

In some embodiments, the model manager 370 may create persona models that are stored in person model storage 210. Persona models are created to represent a specific role or entity as previously described. In some embodiments, model manager 370 may create classifications models that are stored in classification model storage 209. Classification models are variants of persona models for groups or segments that share one or more common attributes. Classification models are more tightly aligned with the group or segment. In some embodiments, classification models may be created for different industries. In some embodiments, classification models may be created for different demographics. In some embodiments, classification models may be created for different organizational levels within a company. For example, a classification model for recipients at a director level may be created. Classification models may be created for any user attribute or combination of user attributes that a group of users can be built around. Q&A pairs that are specific to the segment are used to train and test the classification model. In some embodiments, the questions for the questions and answer pairs are extracted from actual responses to messages sent to the recipients from campaign controller 250, wherein the recipients are part of a group of recipients that share one or more attributes.

In some embodiments, once the model is trained, Q&A pairs from testing Q&A pairs storage 353 are used to validate the model's behavior. In some embodiments, the answers that a trained model generates during a testing phase are reviewed by one or more Q&A workers 315 to determine how appropriate they are. In some embodiments, Q&A workers 315 use a ranking to represent how close the answers generated by the model are to the answers of the testing Q&A pairs. In some embodiments, the answers generated by the model to the questions of the testing Q&A pairs are graded on a Likert scale with 1 being the worst response and 5 being the best response.

In some embodiments, model controller 320 determines model parameters when creating a model using a neural network. In some embodiments, model controller 320 determines how many neurons will be in the model. In some embodiments, model controller 320 determines how many layers will be in the model. In some embodiments, model controller 320 determines one or more of an amount of backpropagation, a dimension, and a learning rate. In some embodiments, the model parameters determined by model controller 320 when creating a model are referred to as AI configuration super parameters. In some embodiments, AI configuration super parameters are part of a TensorFlow configuration. In some embodiments, AI configuration super parameters are set in Python code or as command line parameters for a python program that trains a model. In some embodiments, the AI configuration super parameters are stored in AI configuration super parameters storage 362. In some embodiments, AI configuration super parameters are stored in a bash script format in AI configuration super parameters storage 362. In some embodiments, AI configuration super parameters are stored in project notes or a readme file in AI configuration super parameters storage 362.

In some embodiments, a model that results from a training and testing process is stored as one of integer values or real values in a matrix in model storage 216. In some embodiments, the matrix aligns to a word matrix. In some embodiments, after the model is built, the model may be further adjusted using a tuning process that adjusts the values of the neurons. In some embodiments, the values of the neurons may be stored in neuron storage 363. In some embodiments, the values of the neurons may be stored with the model in model storage 216. In some embodiments, a model that results from a training and testing process further comprises a metagraph. In some embodiments, a metagraph is a list of operations to execute, and which model inputs to pass to the list of operations. In some embodiments, a metagraph is built by writing a python program that calls TensorFlow APIs to create an execution graph which is stored in memory. In some embodiments, saving an execution graph to a memory creates a metagraph. In some embodiments, a metagraph is a stored version of the in-memory execution graph and is stored in metagraph storage 361. In some embodiments the metagraph is used to execute steps of a neural network. In some embodiments, the metagraph is stored with the model in model storage 216. In some embodiments, serving module 230 retrieves a model from model storage 216 and a corresponding metagraph from metagraph storage 361 and makes the model and the metagraph available to campaign controller 250.

In some embodiments, a model represents a persona. Models may be associated with multiple campaigns, as more than one model may be used in a campaign. Each model may have one or more versions. In some embodiments, AIDA system 215 includes a table which contains a list of all models and the versions of the models that may be used. In some embodiments, a usage counter is maintained for every version of a model, and each time the version of the model is used in an AIDA campaign, the usage counter is incremented. In some embodiments, the model version with the lowest usage count is the next model to be used by a campaign controller. In some embodiments, a security awareness system administrator 288 may set a target use percentage for one or more version of a model. In some cases, campaign controller 250 will use a version of a model for a campaign based on which version of a model is farthest below its target use percentage.

In some embodiments, models are created which select a preferred, or desired kind of training for a user based on recipient information and/or recipient actions when they fail a phishing campaign. In some embodiments, training models are created based on a user's behavior in an AIDA campaign subsequent to completing specific training materials. In some embodiments, training models are created based on a user's behavior in an AIDA campaign after the user has failed a previous simulated phishing campaign and has received training targeted towards the failure mode of the user.

In some embodiments, information from simulated phishing campaigns, information about users, information about accounts, and other information can be used to create new models and to update existing models. For example, one or more neural networks may be trained using results of simulated phishing campaigns, information about users of that simulated phishing campaign and through training establish one or more models. This information may, for example, highlight behavioral differences between people which may be used by the classification models to create segmentations of users into different groups based on certain attributes, wherein each group gets targeting with a specific persona model based on the likelihood that the specific persona model will increase the probability of the user interacting with a link. In some embodiments, historical information is pulled from one or more campaign recipient actions table(s) by historical data exporter 301 and formatted to be used to create a new model or update an existing model to create a new version of an existing model.

Models may be created for segmentations of a population, for clusters in a population, and for any group of a population. For example, a neural network may be trained with data regarding a segment to establish a model for that segment. In some embodiments, AIDA model controller 320 creates one or more models for an individual company (account).

In some embodiments, for a user that has not been part of an AIDA simulated phishing campaign, campaign controller 250 may redact information from users that are grouped according to similar attributes using one or more classification models (e.g. users that are in the same or similar industry, users that have similar seniority in a company, users that perform a similar role in an organization, users that have been with an organization for a similar length of time, users that are in similar geographic locations, etc.). The one or more classification models built using redacted information from users with similar attributes may be used along with personal and generic information for the new user to customize an AIDA campaign for that user, thereby creating an appropriate first AIDA campaign for a user that has no previous AIDA campaign history.

In some embodiments, statistical models may be used for persona models, classification models, clustering models, timing models, or any other type of model. In some embodiments, logistic regression models may be used for persona models, classification models, clustering models, timing models, or any other type of model. In some embodiments, k-means models may be used for persona models, classification models, clustering models, timing models, or any other type of model. In some embodiments, polynomial regression models may be used for persona models, classification models, clustering models, timing models, or any other type of model. In some embodiments, models may be based on deep neural networks, which can be used to create models including, for example, statistical models such as logistic regressions. In some embodiments, a deep neural network used is a sequence to sequence (seq2seq) deep neural networks model (also known as neural machine translation).

In some embodiments, information about a user that has interacted with a link, such as one or more of a browser the user was using when they performed the action, whether the user performed the action on their phone, a time of the action, an email client used, an IP address of the user, a browser user agent, a user's operating system, and a browser version may be used to create models, to choose a model for a specific user, or as a feedback loop to include behavior in serving module 230 which may inform things such as a next action in a template, a next template detail page, a next timing for sending a next message, etc.

In some embodiments, one or more historical data exporters 301 reads data from one or more storages and creates files in the correct format needed by the model controller 320 to train new models, retrain existing models, or tune existing models. In some embodiments, one or more historical data exporter s301 reads data from campaigns storage 201. In some embodiments, one or more historical data exporters 301 reads data from campaign recipients storage 202. In some embodiments, one or more historical data exporters 301 reads data from campaign recipient actions storage 220. In some embodiments, one or more historical data exporters 301 reads data from scenario descriptions storage 310.

### C. Risk Score Determination

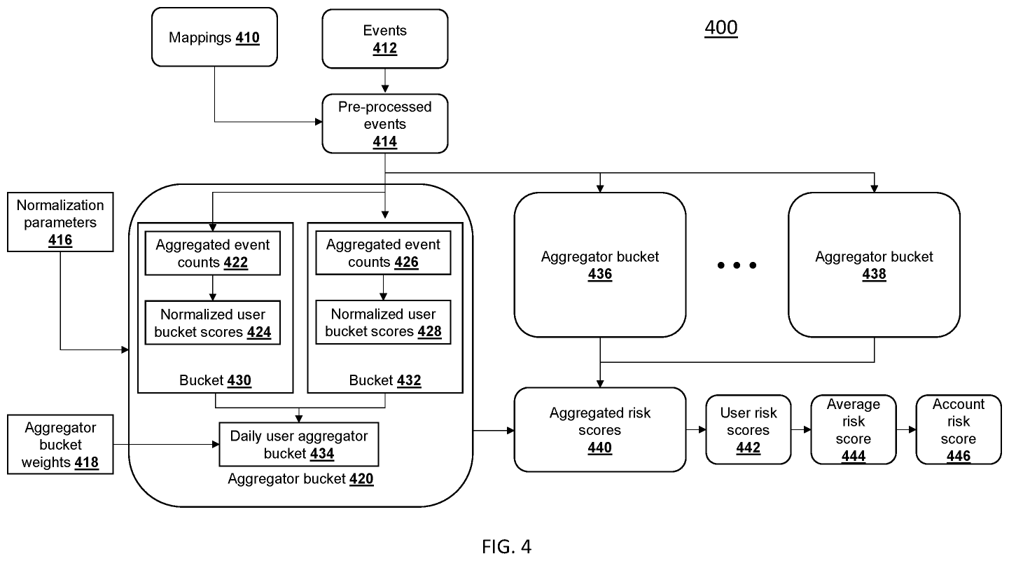

FIG. 4 depicts an example of data exchange and analysis by systems capable of generating risk scores. In some implementations, the data exchange and analysis may be performed by one or more servers (e.g., one or more servers that are the same as, or similar to, servers 106, and/or other servers described herein) and/or by one or more client devices (e.g., one or more clients that are the same as, or similar to, clients 102, and/or other clients described herein). Additionally, or alternatively, one or more storage devices (e.g., one or more storage devices that are the same as, or similar to, storage 128 and/or other storages described herein) may be involved in one or more aspects of the data exchange and analysis illustrated by FIG. 4.

In some embodiments, a level of risk (which can be represented as a risk score) can represent activities involved in analyzing, assessing, remediating, and reporting risks attributable to users (sometimes referred to as the human layer) in an organization. As described herein, level of risks can represent all elements of risk attributable to users at the user (e.g., individual) level or the organization level. When the below-described techniques are implemented, some or all elements of the level of risk of a user and corresponding devices can be represented as a single level of risk (e.g., a single metric or risk score) that is transparently computed, is highly explainable, and aligned to cybersecurity best practices. The level of risk can be a key indicator of the risk posed by a user or a group of users of the organization. Ultimately, the analysis and reporting of risk scores representing a level of risk as described herein can contribute to the goal of continuous improvement in cybersecurity behaviors of users and groups of users in organizations. In some embodiments, a risk score corresponds to a value between 0 to 100, where lower values correspond to lower risk and higher values correspond to higher risk. It will be understood that other scales may be used to describe the level of risk associated with one or more users.

In some embodiments, one or more events 412 (referred to individually as event 412 and collectively as events 412) are created and/or received by one or more servers. For example, the one or more servers may create the one or more events 412 in response to receiving data generated during an event campaign (e.g., campaigns similar to those described herein such as the AIDA simulated phishing campaigns, simulated phishing attack campaigns, and/or the like). The data received during the event campaign may be associated with (e.g., represent) input received from one or more client devices (not explicitly shown). In this example, where a user engages (e.g., responds to a simulated phishing message) during the event campaign via a client device, the data generated and transmitted back to the server is stored by the server as the events 412. Additionally, or alternatively, the data generated may be stored on the client device involved until requested from one or more servers.

In some embodiments, events 412 include data associated with one or more aspects of the events 412. As an example, such aspects can include client device identifiers, corresponding event and action identifiers, event timestamps, and/or the like. In some embodiments, the events 412 represent one or more security risks associated with one or more users to an organization. For example, an event 412 may represent one or more security risks based on (e.g., corresponding to) actions taken by users via client devices during the event campaign and/or classifications of the events 412.

In some embodiments, each event 412 may represent an action associated with the event 412, such as an interaction between a user and their client device during the event campaign. For example, an event 412 may represent an action where a user responds to a simulated phishing message (e.g., a suspicious email aimed at soliciting a response from the user during the event campaign). In examples, the actions can be associated with varying degrees (or levels) of risk. For example, the server may generate data associated with actions involving client devices, the actions initiated by users that are targeted during an event campaign. In some embodiments, the server may update one or more aspects of the events 412 based on the actions involved.

In some embodiments, the server may classify events. For example, the server may classify events as risky events, secure events, and/or mitigation events based on the actions involved. In some embodiments, the server may classify an event as a risky event based on an action where a user interacts with their client device to select an unsecure link (e.g., a phishing link) that, if sent by a malicious actor, could enable the malicious actor to gain certain controls over the client device and/or information that is not intended to be exchanged. In another embodiment, the server may classify an event as a risky event based on an action where a user responds to a message (e.g., an email) via a client device, the message having been sent by a malicious actor attempting to soliciting a response. In yet another embodiment, the server may classify an event as a risky event based on an action where a user ignores a message from a malicious actor, the message attempting to solicit a response. In some embodiments, the server may classify an event as a secure event based on an action where a user interacting with their client device to report a phishing attempt. In some embodiments, the server may classify an event as a mitigation event based on an action where a different user interacts with a different client device to address the risky event. As an example, a mitigation event may involve the different user interacting with a different client device (e.g., a client device assigned to the different user) to cause one or more actions to be performed (e.g., by the server and/or the client device that responded to create the risky event) that mitigate the risky event. An example of a mitigation includes causing one or more security tips and/or other instructions to be displayed via the client device involved in the risky event. Another example of a mitigation includes the different user (e.g., an IT administrator) addressing a credential breach by resetting the user's credentials and/or causing a message to be sent to the client device that responded to create the risky event to reset their password. The classifications and events described are intended to be examples and are not intended to limit the present disclosure.

In some embodiments, the server may process the events to generate pre-processed events 414. For example, during an event campaign, the server may receive data associated with responses from the client devices, determine one or more corresponding events 412 based on receiving the data from the client devices, generate the data associated with the events 412, and store the generated data in storage associated with (e.g., controlled by) the server. In some embodiments, the server processes the events either immediately or at predetermined points in time corresponding to predetermined time intervals. For example, the server may process the events as they occur or at predetermined points in time relative to an event campaign (e.g., at the beginning, during, or at the end of the event campaign).

In some embodiments, the pre-processed events 414 are assigned a level of risk (e.g., a risk score that represents one or more elements of risk involved in interactions based on user input, the risk score being explainable and deterministic based on the one or more elements of risk when correlated with one or more users). For example, the server may assign the pre-processed events 414 (e.g., pre-processed events 414 associated with one or more data sources) a level of risk. In some embodiments, the server assigns a level of risk to each of the pre-processed events 414 based on one or more aspects associated with the pre-processed event 414. For example, the server may assign a level of risk to each of the pre-processed events 414 based on the server determining a classification (e.g., a type) for each pre-processed event 414 (e.g., that the event is a risky event, secure event, and/or mitigation, described above). Additionally, or alternatively, the server may assign a level of risk to each of the pre-processed events based on the user involved in the event.

For example, the server may assign a first level of risk to an event involving a first user (e.g., an employee not involved in the organization's information technology (IT) department) and a second level of risk to an event involving a second user (e.g., an employee involved in the organization's IT department). In this example, where the event is a risky event, the first level of risk may be lower than the second level of risk, given the access the second user has to one or more of the organization's critical systems is likely greater than the access the first user has. In some embodiments, the server assigns a level of risk to pre-processed events 414 based on the amount of time the user has been associated with (e.g., employed by) an organization. For example, the server may assign a first level of risk to a pre-processed event 414 involving a first user (e.g., an employee involved with the organization for more than a predetermined period of time) and a second level of risk to a pre-processed event 414 involving a second user (e.g., an employee an employe involved with the organization for less than the predetermined period of time). In this example, the server may assign a second level of risk that is higher than the first level of risk based on an offset associated with new users (e.g., new employees). This offset may be used to update (e.g., increase) the level of risk for that user based on the increased chance that the user may not have received the appropriate training on how to avoid risky events. In this way, the level of risk may be determined such that the level of risk represents an overall risk attributable to a user or users and corresponding device(s). As will be appreciated, by virtue of assigning the level of risk based on the offset associated with the new users, the level of risk can be determined such that the level of risk represents the heightened risk associated with the new users as they onboard over a period of days (e.g., 30 days, 60 days, 90 days, and/or the like). In some embodiments, the offset is added to the level of risk.

In some embodiments, training (e.g., security awareness training) and simulated phishing attacks (e.g., tests) enable continuous improvement of cybersecurity behaviors of users when interacting with corresponding devices. By sourcing events that capture risky and secure events from different data sources (endpoint security vendors, web security vendors, training completions/expiry, phish reporting, etc.) involved in use of devices by users of an organization, systems implementing the techniques described herein can continuously assess risk profiles for each user and create detailed risk profiles for each user and/or groups of users. From that data, gaps in each users cybersecurity awareness can be identified. And system administrators (e.g., security personnel) can use the risk scores (and identified gaps in the users' cybersecurity awareness) to train users on behaviors that will then lower overall risk to the organization, thereby promoting less risky (e.g., more secure) behaviors while not promoting more risky (e.g., less secure) behaviors.

In some embodiments, the server may associate one or more events 412 with one or more buckets 430, 432 based on mappings 410. For example, where mappings 410 represent correlations between aspects of the events 412 and one or more buckets (e.g., buckets 430, 432, and/or the like), the server may identify each event 412 as being associated with the one or more correlated buckets. Additionally, or alternatively, the server may map the events 412 to the buckets based on correlated classifications of the events, and/or the like. In some embodiments, the server stores the events 412 and information representing their corresponding buckets 430, 432 as a set of pre-processed events 414. In some embodiments, the mappings 410 may cause the server to associate the events 412 with multiple buckets 430, 432.

In some embodiments, the pre-processed events 414 are assigned to one or more buckets 430, 432. Although FIG. 4 illustrates two buckets 430, 432 associated with aggregator bucket 420, embodiments may include more, or fewer buckets associated with aggregator bucket 420. Additionally, while detailed reference to buckets 430, 432 will be made in association with aggregator bucket 420, aggregator buckets 436, 440 (and/or aggregator buckets not explicitly illustrated) may likewise include one or more buckets that are not explicitly shown. The buckets of aggregator buckets 436, 438 may be the same as, or similar to, buckets 430, 432.

In some embodiments, the server assigns the one or more pre-processed events 414 to bucket 430 and/or bucket 432 based on mappings 410. For example, the server may assign pre-processed events 414 associated with actions where users clicked on suspicious links in emails to bucket 430. In another example, the server may assign pre-processed events 414 with actions where users reported suspicious links in emails to bucket 432. In these examples, bucket 430 may be further associated with events classified as risky events and bucket 432 may be further associated with events classified as secure events.

In some embodiments, the server assigns pre-processed events 414 associated with actions where a different user mitigates the actions of a user initially involved in an event campaign to the same bucket 430, 432 to which the server assigned the pre-processed event 414 involving the risky event. For example, the server may assign the related risky and mitigating pre-processed events 414 in the same bucket 430, 432. In this example, the server may later update the risk score associated with the risky event based on the risk score associated with the mitigating event (e.g., when aggregating the risk scores as described herein). This update may involve reducing the risk score of the risky event by a value (e.g., by the value of the risk score associated with the mitigating event) and/or a percentage (e.g., a predetermined percentage).

In some embodiments, the server assigns events 412 included in the one or more pre-processed events 414 to buckets 430, 432 that are associated with ranges of risk scores. For example, the server may assign the pre-processed events 414 having a risk score that satisfy a first range of risk scores to bucket 430, and the pre-processed events 414 with risk scores that satisfy a second range of risk scores to bucket 432. In this way, the server may associate pre-processed events 414 with other pre-processed events 414 that have the same, or similar, risk scores. In some embodiments, risk scores can be represented on a scale from 1 to 100, with lower values corresponding to lower risks.

In some embodiments, the server aggregates the pre-processed events 414 assigned to each bucket 430, 432. For example, the server may aggregate the pre-processed events 414 assigned to bucket 430 as an aggregated event count 422, and the pre-processed events 414 assigned to bucket 432 as an aggregated event count 426. In these examples, the data associated with the pre-processed events 414 may be included in aggregated event counts 422. Additionally, or alternatively, a value corresponding to the number of the pre-processed events 414 that further correspond to respective buckets 430, 432 may be stored as the aggregated event counts 422, 426. In this example, the value may be stored as a listing of events (e.g., listed by identifier) and corresponding risk scores. In some embodiments, the aggregated event counts may represent one or more counts corresponding to events that are riskiest events or events that are safest events. As described herein, riskiest events can include events that represent user interactions with corresponding devices that correspond to appropriate (e.g., best user behavior) whereas safest events can include events that represent user interactions with corresponding devices that correspond to not appropriate (e.g., worst user behavior).

In some embodiments, the server normalizes the risk scores assigned to the pre-processed events 414 associated with each bucket 430, 432. For example, the server may normalize the risk scores based on one or more normalization parameters 416. The normalization parameters may include a number of look back days, weights used to modify the risk scores, predetermined risk scores assigned to certain events (e.g., safest events or riskiest events associated with each bucket 430, 432), and/or the like. In some embodiments, when the server normalizes the risk scores based on a number of look back days, the server may include (e.g., assign a weight of 1) to the risk scores of pre-processed events 414 that fall within the number of look back days. In one example, if the number of look back days is 30, the server may include all the pre-processed events 414 assigned to a bucket 430, 432 that occurred within the last 30 days and the server may exclude (assign a weight of 0) to all the pre-processed events 414 that are outside of the last 30 days. In this way, the server may evaluate only the pre-processed events 414 that are temporally relevant and may reduce the impact of (or exclude) the pre-processed events 414 that are less temporally relevant. In some embodiments, when the server normalizes the risk scores of pre-processed events 414 based on weights, the server may include (e.g., assign a weight) to the risk score based on a relative importance of event classifications, buckets 430, 432, or aggregator bucket 420, 436, 438 to an organization's overall risk. In some embodiments, the weights may include values ranging along a scale from 1 to 10, where 1 is a lowest level of importance and 10 is a highest level of importance when measuring risk. In some embodiments, different scales can be used (e.g., from 0 to 100). For example, for pre-processed events 414 that are classified as risky events, higher weights may be assigned in cases where users clicked on suspicious links, and lower weights may be assigned in cases where users ignored or deleted an email that attempted to cause the user to click on the suspicious links. In some embodiments, where the server normalizes the risk scores of pre-processed events 414 based on predetermined risk scores, the server may assign weights that are assigned to the pre-processed events 414 based on their classifications and/or based on one or more attributes associated with the pre-processed events 414. In some embodiments, the sever may multiply the risk score for each event by the corresponding weight to determine an updated risk score for each of the pre-processed events 414 assigned to corresponding buckets 430, 432. In some embodiments, the weight may be represented as percentage (e.g., a decimal) or on a scale from 1 to 10, with lower values corresponding to events of lower importance.

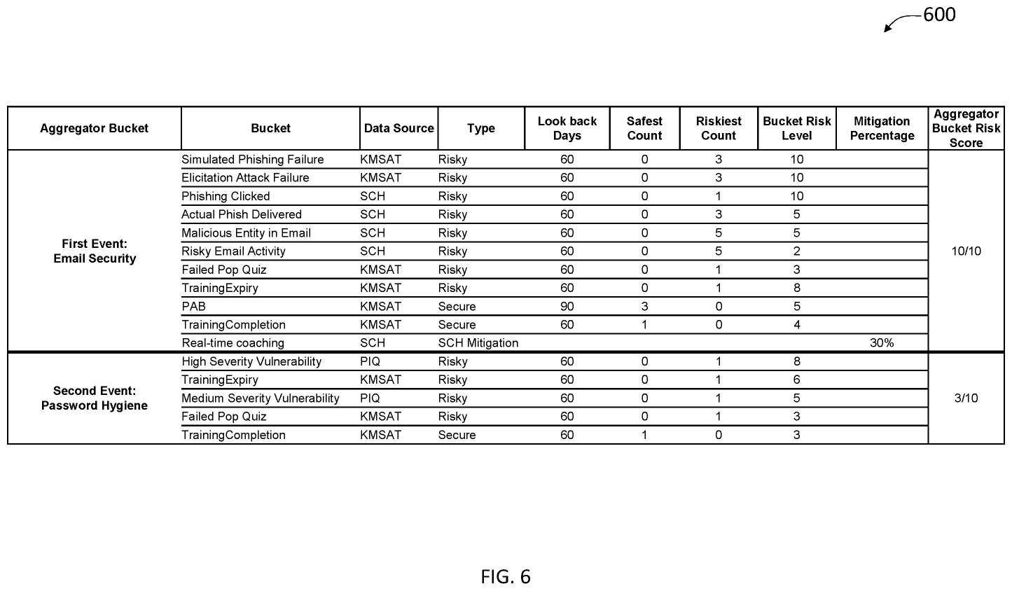

In some embodiments, the server may update the risk scores of pre-processed events 414 based on their correspondence with one or more aggregator buckets 420, 436, 438. For example, an aggregator bucket weight 418 may be a weight that is used to update the risk scores of all pre-processed events 414 corresponding to an aggregator bucket 420, 436, 438. The server may multiply the risk scores of each of the pre-processed events associated with the buckets of a given aggregator bucket with the same weight. This enables the server to increase or decrease the relative importance of groupings of pre-processed events 414 that otherwise would fall into separate buckets. In some embodiments, the server then stores the risk scores of all pre-processed events 414 in a daily user aggregator bucket 434. For example, the server may store the risk scores in the daily user aggregator bucket 434 based on one or more users being involved in one or more events on a given day (e.g., a current day) or a set of days (e.g., a number of days that extend from the current day to at least one or more days prior). Examples of the delineation of risk scores across buckets and aggregator buckets are described with respect to FIG. 6.

In some embodiments, the server generates aggregated risk scores 440. For example, the server may generate a list of aggregated risk scores 440 based on the pre-processed events 414 included in each daily user aggregator bucket 434. The aggregated risk scores 434 may be represented as values corresponding to the level of risk (which can be represented as a risk score) determined for each pre-processed event 414 included in each bucket 430, 432 and/or each aggregator bucket 420, 436, 438. In some embodiments, the aggregated risk scores 440 are further associated with users involved in the one or more pre-processed events 414. In some embodiments, the server may update the values of aggregated risk scores 440 based on a type of user corresponding to each score in the aggregated risk scores 440. For example, the server may update (e.g., increase) the aggregated risk scores 440 associated with users that have more influence in the organization (e.g., directors, managers, and/or the like with fewer access controls applied to their accounts than other employees). In examples, the server may update (e.g., decrease) the aggregated risk scores associated with users that have less influence in the organization (e.g., employees that have greater access controls than other employees (e.g., entry-level employees and/or the like with greater access controls applied to their accounts). In some embodiments, the server may update (e.g., increase or decrease) the aggregated risk scores 440 associated with users based on their position in the organization's hierarchy. For example, the server may increase (e.g., add a predetermined value or increase by a predetermined percentage) the aggregated risk scores 440 associated with users as they increase in hierarchy in the organization. In some embodiments, the server may update the aggregated risk scores 440 associated with users based on receiving input from a client device. For example, an IT administrator may provide input via their client device to set one or more aggregated risk scores 440 for one or more users. In some embodiments, the server may update the aggregated risk scores 440 associated with the users based on the users providing input or forgoing providing input via a client device. For example, where users do not interact with one or more applications (e.g., do not use email and/or the like) the server may determine that such users forwent providing input. In this example, the server may then update the risk score by adding a risk score associated with the user. In this way, the server may normalize certain pre-processed events 414 (e.g., the risk scores of the pre-processed events 414) using the one or more buckets 430, 432 and/or the one or more aggregator buckets 420, 436, 438 and the server may update certain pre-processed events 414 separate from the normalized pre-processed events 414.

In some embodiments, the server generates a list of user risk scores 442. For example, the server may generate the list of user risk scores 442 based on the aggregated risk scores 440. In one example, each user involved in one or more of the pre-processed events 414 is associated with one or more user risk scores 442 corresponding to the pre-processed events 414. In some embodiments, the server generates average risk scores 444 for each user. For example, the server may generate the average risk score for each user by averaging the user risk scores 442 corresponding to each user. In this way, the server may calculate and maintain risk scores for individual users (e.g., employees) of an organization. The server may have access to information from systems that protect multiple threat vectors, and other systems that monitor user behaviors. The server may generate a list of user risk scores 442 that are explainable, deterministic and actionable and enable the assignment of appropriate training based on areas that resulted in increases to the risk score of a user or group of users within an organization. The server may be configured to incorporate or remove criteria by which a user risk score 442 is determined in response to the addition of new and different types of data that could further refine the risk score, thereby improving the accuracy and coverage of various events that reflect the level of risk to the users and organization.

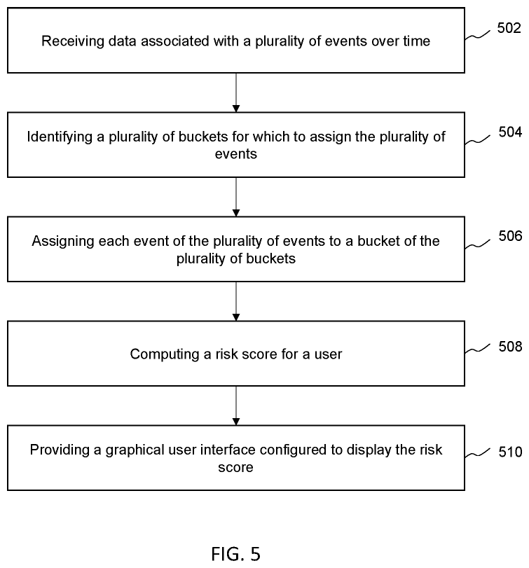

In some embodiments, the server computes account risk scores 446 for accounts associated with users. For example, the server may compute the account risk scores 446 based on the average risk scores 444. In this example, the server may associate the account risk scores 446 with accounts corresponding to users. The server may then take one or more steps to reduce the account risk scores 446 as a whole or on an individual (user-by-user) basis. Examples of steps that may be taken include causing electronic training to be provided with users with accounts having certain account risk scores 446, suspending accounts (e.g., account access) that are associated with certain account risk scores 446, and/or the like. Additional examples of events are described in greater detail with reference to FIG. 5.

FIG. 5 depicts a flowchart of a process 400 for generating risk scores, according to some embodiments. In embodiments, one or more of the steps described with respect to process 500 may be performed (e.g., completely, partially, and/or the like) by one or more servers (e.g., one or more servers that is the same as, or similar to, the server 106 of FIGS. 1A and 1B and/or other servers described herein). In some embodiments, one or more of the steps of process 500 may be performed (e.g., completely, partially, and/or the like) by another computing device or a group of computing devices separate from and/or including the one or more servers, such as by a client device (e.g., a client device that is the same as, or similar to, the client device 102 of FIGS. 1A and 1B and/or other client devices described herein).

In a brief overview of the process 500, at step 502, a plurality of events over time related to security risk of one or more users to an organization are received. At step 504, a plurality of buckets for which to assign the plurality of events are identified. At step 506, each event of the plurality of events is assigned to a bucket of the plurality of buckets. At step 508, a risk score for a user of the one or more users is computed. And at step 510, a graphical user interface configured to display the risk score is provided.

Step 502 includes receiving a plurality of events over time related to security risk of one or more users to an organization. For example, one or more servers may receive the plurality of events (e.g., data associated with the plurality of events) over time. The plurality of events may be associated with an event campaign, whereby the one or more servers probe the one or more client devices to determine a level of risk associated with each client device. In some implementations, events may represent activity, events, issues, errors, user interactions, user actions, lack of user interactions, and/or the like that are simulated or actual. In some implementations, simulated events may include one or more events initiated by a client device that is involved in testing the security of one or more other client devices. In some embodiments, the security risk is based on one or more risk scores of one or more users involved in the events during the time, and indicates a degree to which users of an organization may be likely to respond to a simulated (or real) phishing attack described herein.

The plurality of events may be associated with (e.g., correspond to) one or more client devices that are being tested. For example, the one or more servers my generate data associated with one or more events (e.g., simulated phishing attacks and/or the like) and transmit the data to the one or more client devices (e.g., via email services, electronic messenger services, social media services, and/or the like). The data transmitted to the one or more client devices may then be configured to cause a display of the one or more devices to display a prompt soliciting input from users of the one or more client devices.

In some implementations, one or more users of the one or more client devices uses the respective client devices to provide input or forgo providing input based on the display of the prompt soliciting the input. For example, in response to the display of a prompt soliciting input involving the selection of a uniform resource locator (URL) during a simulated phishing attack, the one or more client devices may receive input from a user in response to displaying the prompt. In some examples, the input may be the selection of the URL by the user. In other examples, the input may correspond to the reporting of a phishing attack. For example, in the case of email messages, an icon may be included that, when selected by a user, reports a given email as soliciting input as part of a phishing attack. In some examples, the input may correspond to the user forgoing action (e.g., deleting an email including the prompt, clicking away from the email including the prompt, and/or the like). In some implementations, the client devices then capture the input and provide the input to the one or more servers involved in the testing of the client devices.

In some implementations, each event is associated (e.g., corresponds to) a type. For example, a type may be a risky event (e.g., events involving an action where a user interacts with their client device to select an unsecure link (e.g., a phishing link), a user responds to a message (e.g., an email corresponding to the phishing attack), and/or a user ignores a message corresponding to the phishing attack (e.g., does not report the message), and/or the like). In another example, a type may be a secure event (e.g., an event where a user interacting with their client device to report a phishing attempt). In examples, a type may be a mitigation event (e.g., where a different user interacts with a different client device to address the risky event). An example of a mitigation event includes an event where the different user causes one or more security tips and/or other instructions to be displayed via the client device involved in the risky event. Another example of a mitigation event includes the different user (e.g., an IT administrator) addressing a credential breach by causing the user's credentials to be reset and/or causing a message to be sent to the client device that responded to create the risky event to reset their password. It will be understood that mitigation events can reduce the risk of an event (such as a risky event) that may affect the cybersecurity of an organization. In some implementations, the different user provides input to a different client device (e.g., a client device associated with the different user) to cause one or more actions to occur (e.g., causing security tips to be displayed, resetting passwords in response to a credential breach, and/or the like). In some embodiments, the one or more servers classify each event based on the type associated with the event.

Step 504 includes identifying a plurality of buckets for which to assign the plurality of events (e.g., events that pose a similar risk level to the organization) . . . . For example, the one or more servers may identify the plurality of buckets for which to assign the plurality of events. In some implementations, the one or more servers identifies the plurality of buckets based on one or more aspects of the one or more events. For example, when the one or more servers tests the client devices to determine their susceptibility to events involving the provision of personal information, the one or more servers may then identify buckets (and corresponding aggregator buckets) that are associated with events where personal information is solicited. In another example, when the one or more servers tests client devices associated with new employees, the one or more servers may then identify buckets that are associated with events that target new employees. In examples, the one or more servers may identify buckets that are associated with events having the same type as the one or more events received (e.g., at step 502).

In some implementations, the server identifies the plurality of buckets, where each bucket further identifies a collection of events that are assigned a level of risk from a plurality of levels of risk (also referred to as risk scores). For example, the server may identify the plurality of buckets, where each bucket is associated with a range of risk scores. In this example, buckets and their corresponding range of risk scores may be further assigned a weight. For example, a range of risk scores may be assigned a wight based on one or more aspects associated with the events of the bucket. In an illustrative example, higher weights may be associated with ranges of scores where each score within the range corresponds to an event that introduces more risk than different events. An example of an event that may be associated with high weights includes an event involving users engaging with the simulated phishing events. Conversely, an example of an event that may be associated with a lower weight includes an event involving users forgoing engaging with the simulated phishing events. In the case of users forgoing such engagement, although the events involved may be classified as risky events, the one or more servers may assign a lower weight to such events when grouped in a bucket given that the chances of the simulated phishing attempt being successful in the future (e.g., after a user deletes a simulated phishing message) remain low.

With continued reference to step 504, the one or more servers may identify the plurality of buckets for which to assign the plurality of events based on one or more models. For example, the one or more servers may provide data associated with the plurality of events to a model (e.g., a neural network or any other suitable model described herein) to cause the model to provide an output identifying the one or more buckets for which to assign each event of the plurality of events. In this example, the one or more servers may train the model to provide the output using supervised learning techniques. For example, the one or more servers may train the model by providing events and tags (further corresponding to aspects of each event) to the model during training to cause the model to correctly classify aspects of subsequent events. In examples, a first tag may correspond to an event type for each event (e.g., a risky event, a secure event, a mitigation event). In use, the one or more servers may identify the plurality of buckets for which to assign the plurality of events based on the identification of the one or more corresponding aspects of each event.

Step 506 includes assigning each event into a bucket of the plurality of buckets. For example, the one or more servers may assign each event of the plurality of events into a bucket. In some implementations, the one or more servers assigns the events to the buckets based at least on a type of each event. For example, the one or more servers may assign risky events to a first bucket, and the one or more servers may assign secure events to a second bucket. In this example, the one or more servers may further assign one or more mitigation events that correspond to the one or more risky events to the first bucket. The one or more mitigation events may be associated with a mitigation percentage (e.g., a percentage by which a mitigation event will reduce the risk associated with a corresponding event, such as a corresponding risky event). In some embodiments, the one or more servers assigns each event into corresponding buckets based on one or more aspects associated with each event. For example, where events share one or more similarities for a given aspect (e.g., events conducted by newer employees) the one or more servers may assign the events to one or more representing that similarity (e.g., one or more buckets corresponding to newer employees).

In some implementations, the one or more servers assign each of the buckets of the plurality of buckets to an aggregator bucket (sometimes referred to as a “super bucket” that represents a collection of buckets that are logically grouped to represent related elements of risk). For example, the one or more servers may determine that one or more buckets represent related elements of security risk (e.g., the buckets include events with aspects that are the same as, or similar to, aspects of other events in other buckets) and the one or more servers may then assign the one or more buckets with the related elements of security risk to an aggregator bucket. In some implementations, the one or more servers assign each of the buckets to one or more of the plurality of aggregator buckets, where each of the aggregator buckets is assigned a second weight. For example, the second weight may be associated with (e.g., correspond to) a second level of risk that is further associated with the related elements of security risk. In some implementations, where the one or more servers assigns buckets to an aggregator bucket, the events may share common aspects such as common users or groups of users. In a first example, individuals associated with one or more hierarchies or roles corresponding to management may be assigned to a first aggregator bucket, and individuals associated with different hierarchies or roles that do not correspond to management (e.g., entry-level employees) may be assigned to a second aggregator bucket. In this example, the one or more servers may further assign the first aggregator a first weight and the second aggregator a second weight, the first weight being greater than the second weight. In this way, the one or more servers may update the weights of events to reflect the relative importance of the events as they apply to certain aspects held in common (e.g., user bases) among certain events but not others (e.g., specific event types).

With continued reference to step 506, the one or more servers may assign each event into a bucket of the plurality of buckets and/or into an aggregator bucket including a collection of one or more buckets based on the output of the one or more models described above with respect to step 504. For example, the one or more servers may provide the data associated with the plurality of events to the model to cause the model to provide an output identifying the type of each of the events. The one or more servers may then assign the one or more events to one or more buckets, where the one or more buckets correspond to the types of the events. In examples, the one or more buckets further correspond to one or more aggregator buckets as described herein. In these examples, the one or more servers may assign the one or more events to the one or more aggregator buckets based on the output of the models.

Step 508 includes computing a risk score for a user. For example, the one or more servers may compute (e.g., determine) a risk score for a user of the one or more users representing a level of risk associated with the user of the one or more users. In some embodiments, the one or more servers may compute the risk score for the user based on a function of the weight assigned to each bucket and/or a quantity of events in each bucket involving the user. Additionally, or alternatively, the one or more servers may compute the risk score for the user based on a function of a second weight assigned to each aggregator bucket. In some embodiments, the function may include multiplying a predetermined risk score corresponding to a given type of an event against a weight. Additionally, or alternatively, the function may include adding the predetermined risk score corresponding to the given type of the event with a predetermined weight. In some embodiments, the level of risk may represent a degree to which a user complies with cybersecurity best practices. For example, the level of risk may be based on one or more of a number of look back days, one or more bucket or aggregator bucket weights, riskiest counts, safest counts, and/or the like may be used to determine the risk scores as described herein. Accordingly, the level of risk can reflect one or more specific aspects regarding user activity along with their relative impact to the risk associated with the activities performed by the user when engaging with corresponding devices.

With continued reference to step 508, the one or more servers may compute the risk score for the user of the one or more users using the models described above with respect to steps 504 and 506. For example, additional or alternative to the computation of the risk score based on the function of the weight assigned to each bucket, the function of the second weight assigned to each aggregator bucket, and the quantity of events in each bucket, the one or more servers may train the models to generate the risk score. In some embodiments, the one or more servers may train the model by providing events and tags (further corresponding to aspects of each event described herein) to the model during training to cause the model to correctly predict risk scores of the events. In this example, a tag (e.g., a third tag) may correspond to a risk score for each event. In use, the one or more servers may provide data associated with events to the models to cause the models to provide the risk scores as outputs. In some embodiments, the model is trained to compute the risk score based on the weights associated with the buckets and/or the second weights associated with the aggregator buckets. For example, during training, the one or more servers may provide tags associated with (e.g., representing) the weights associated with the buckets and/or the second weights associated with the aggregator buckets that correspond to each event to further cause the model to correctly predict the risk scores of events based on the above-noted weights.

Step 510 includes providing a graphical user interface configured to display the risk score. For example, the one or more servers may provide a graphical user interface configured to display the risk score and/or one or more recommendations for mitigations. In some implementations, the one or more servers may generate data associated with the graphical user interface, where the data is configured to cause a display to output the graphical user interface. In some embodiments, the one or more servers may provide a graphical user interface configured to display the risk score and information identifying reasons computation of the risk score changes over time for the user. For example, in response to multiple event campaigns (described herein), the one or more servers may monitor the risk score of the user and determine one or more reasons for changes in the risk score. In one example, in response to a user opening a simulated phishing message on a client device and responding to the simulated phishing message via the client device, the one or more servers may calculate a first risk score. The one or more servers may then target the client device by sending another simulated phishing message associated with (targeted at) the user, and the user may then provide input via the client device that indicates the email is associated with a phishing attempt. Once the simulated phishing message is successfully reported, the one or more servers may calculate a second risk score that is lower than the first risk score, indicating that the user is better able to identify simulated (or real) phishing attempts. This may be, for example, based on one or more trainings assigned to the user between when the first simulated phishing message and second simulated phishing message were sent to the user. The one or more servers may then provide a graphical user interface that displays the risk score changing over time as well as a determined reason for the change (in this example, that the one or more trainings enabled the user to better identify the simulated phishing attempts). In some embodiments, the one or more servers provides the data associated with the graphical user interface to cause a client device (e.g., a client device controlled by an IT administrator and/or the like) to display the risk score and/or recommended mitigations.

In examples, the one or more servers may provide a graphical user interface including one or more risk scores and one or more recommendations for mitigations. For example, the one or more servers may provide a graphical user interface representing risk scores for one or more users. In this example, where users satisfy a first (low risk) threshold, the one or more servers may show a recommendation to take no action or to initiate an event campaign for the users having a risk score that satisfies the first threshold. In another example, where users satisfy a second (medium risk) threshold, the one or more servers may show a recommendation to initiate an event campaign for the users that satisfy the second threshold or provide an electronic training to the one or more users having a risk score that satisfies the second threshold. In yet another example, where users satisfy a third (high risk) threshold, the one or more servers may show a recommendation to provide an electronic training to the one or more users or to reset the password or credentials of the one or more users having a risk score that satisfies the third threshold.

In some embodiments, the one or more servers identifies one or more recommendations for mitigations based on risk factors identified while generating risk scores. For example, the one or more servers may identify the one or more recommendations for mitigations based on actions involved in one or more events. In one example, where a user provides sensitive information via a client device during an event, the one or more servers may determine that the sensitive information was provided that would have compromised the security of the user's account. In this example, the one or more servers may identify a corresponding training (e.g., a virtual training identifying features associated with the event that were not consistent with a valid request for the sensitive information) and provide data associated with the corresponding training to the client device involved. The data associated with the corresponding training may be configured to cause the client device to display the training via the display of the client device.

In some embodiments, the one or more servers may determine an action to take based on one or more risk scores. For example, the one or more servers may determine an action to take based on the one or more servers computing the one or more risk scores. In some embodiments, the one or more servers may determine a correlation between one or more actions and the one or more risk scores. For example, where a user interacts with a client device to respond to a simulated phishing message, the one or more servers may determine the response corresponds to a risk score that further corresponds to providing electronic training to a user as described herein. In this example, the risk score may be within a range of risk scores that further correspond to providing the electronic training. In some examples, where a different user interacts with a client device to ignore a simulated phishing message, the one or more servers may determine the response corresponds to a risk score that further corresponds to forgoing providing electronic training to the different user. Additionally, or alternatively, the one or more servers may determine the response (the ignoring) corresponds to the initiation of a simulated phishing campaign involving the client device associated with the different user. In this way, the one or more servers may confirm whether or not additional actions are appropriate in view of the subsequent simulated phishing campaigns.

The one or more servers may determine and take an action with respect to any of the embodiments of the security awareness system described in connection with FIGS. 2A-3. The risk scores determined by the one or more servers may be used to create, control and/or execute one or more simulated phishing campaigns. The security awareness system may configure, control and/or execute a simulated phishing campaign directed to one or more users or group of users based on their respective risk scores. The security awareness system may configure, control and/or execute a simulated phishing campaign directed to one or more users or group of users based on a risk score of one or more users with respect to one or more buckets or one or more aggregator buckets. The security awareness system may train, establish and/or retrain and update any one or more AI or machine learning models described herein (such as with respect to FIGS. 2A-3) used by the security aware system to configure, control and/or execute one or more simulated phishing campaigns. For example the risk score(s) of one or more users or group of users may be used as an input to one or more AI or machine learning models for training and/or run-time execution of such models. In other examples, the risk score(s) of one or more users or group of users may be used to identify or select content or a template to use for a simulated phishing communication or campaign. In further examples, the risk score(s) of one or more users or group of users may be used to identify or select which user(s) to provide electronic remediation training and/or the type and content of such training.

In some embodiments, the one or more servers updates the assignment of events into the buckets of the plurality of buckets. For example, the one or more servers may update the assignment of the events based on one or more normalization parameters described herein. As an example, the one or more servers may update the assignment of the events based on a number of look back days. In this example, the one or more servers may remove assignments for events that fall outside of the one or more look back days (e.g., remove assignments for events that are older than a number of look back days e.g., older than 30 days, 60 days, and/or the like, and/or add new events as they are received when the new events fall within the look back days). In some embodiments, the number of look back days may represent a time window (e.g., a time box) during which an event continues to pose risk to an organization. This can ensure that the risk scores generated reflect the current risk to the user or organization as opposed to previous, less temporarily relevant risk.

In some embodiments, the one or more servers may modify the risk score of one or more events based on a booster factor. For example, where the one or more events are assigned to an aggregator bucket (e.g., as described at step 406 of FIG. 4), the one or more servers may assign a weight based on a booster factor (e.g., the one or more servers may increase the weight based on the booster factor). In some embodiments, the booster factor may correspond to a weight that is different from a weight that would otherwise be assigned to a bucket. In some embodiments, the one or more servers may modify the risk score of the one or more events where aspects of the one or more events satisfy the criteria associate with a given booster factor. For example, a higher booster factor (sometimes referred to as an influence booster that is associated with individuals that haver greater influence or control within an organization) may be assigned to events involving individuals that are higher in an organization's hierarchy (e.g., managers, individuals beyond a certain level in an organization's hierarchy, and/or the like) and a lower booster factor may be assigned to events involving individuals that are lower in an organization's hierarchy (e.g., entry-level employees, individuals lower in an organization's hierarchy, and/or the like). In these examples, the one or more servers may increase or decrease the risk score for the users based on the higher or lower booster factors, respectively. In some embodiments, the booster factor may be based on a level (e.g., the relationship between a given user and the broader organization) within an organization associated with a user in relation to one or more other users. Put differently, the booster factor may be based on the depth of an organization and the level at which a particular is located within the depth of that organization. In some embodiments, the booster factor may be based on a number of users at a given level within an organization associated with a user. For example, the booster factor may be based on a percentage of other users at the level of the user, or a percentage of other users at higher and/or lower levels relative to the level of the user. In some embodiments, the booster factor may be based on whether the user is using one or more systems. For example, the boost factor may be associated with whether the user is using one or more systems associated with one or more buckets. In the case where the user is not using the corresponding device to communicate with systems associated with the one or more buckets, the booster factor may be set to a predetermined level (sometimes referred to as an inactive bucket bias). In this way, where a user does not have a score corresponding to a bucket because the user is inactive, is associated with a missing vendor, is associated with an inactive customer, and/or the like, the booster factor may be set to a predetermined level (e.g., 60 out of 100) to represent the risk associated with the user not being an active user.

In some embodiments, the booster factor may be assigned a weight by a user (e.g., a system administrator). For example, the user may provide input to the one or more servers to cause the one or more servers to use the booster factor that is assigned the weight by the user. In examples, setting the booster level based on user input is referred to as a manual booster.

In some embodiments, the one or more servers may modify the risk score of one or more events based on an offset of the user or the organization. For example, where the one or more events are assigned to an aggregator bucket (referenced above), the one or more servers may assign a weight based on an offset of a user or group of users that correspond to the aggregator bucket. In some embodiments, the offset may correspond to a weight that is different from a weight that would otherwise be assigned to a bucket. In some embodiments, the one or more servers may modify the risk score of the one or more events where aspects of the one or more events satisfy the criteria associate with a given offset. For example, a higher offset may be assigned to events involving individuals that recently joined as an employee of an organization (sometimes referred to as an inactive bucket bias), and a lower offset may be assigned to events involving individuals that did not recently join as an employee (e.g., have a longer tenure with the organization). In this way, the one or more servers may increase the risk scores associated with newer employees who may present higher risk than more senior employees.

In some embodiments, the one or more servers may modify the one or more risk scores based on a booster factor and/or an offset using a model. For example, the one or more servers may train a model (e.g., a different model or one or more of the models described above) to modify the risk score based one or more booster factors and/or one or more offsets. For example, during training, the one or more servers may provide tags associated with (e.g., representing) the booster factors and/or offsets that correspond to each event to further cause the model to correctly predict the risk scores of events based on the above-noted booster factors and/or offsets.

By virtue of the implementation of the techniques described herein, events may be analyzed based on specific aspects or groups of aspects associated with the events. This can allow for the clear determination and explanation of aspects corresponding to user interactions with corresponding devices involved in the analyzed events. Further, the techniques described herein enable the scalability of systems implementing these techniques based on the type of events encountered. The systems can be configured to operate in accordance with varying parameters (e.g., varying numbers of look back days, risky or safe event counts, and/or the like).

FIG. 6 depicts an example set of risk scores, according to some embodiments. As illustrated, a first event (e.g., an “Email Security” event) and a second event (e.g., a “Password Hygiene” event) are represented along with criteria by which the first event and the second event are scored. It will be understood that various implementations may include more events, fewer events, and/or different events.

The first event may be associated with an aggregator bucket corresponding to events (e.g., events that are the same as, or similar to, one or more of events 412 of FIG. 4) involving email security. The first event may include an aggregator bucket (e.g., an aggregator bucket that is the same as, or similar to, the aggregator buckets 420 of FIG. 4) that is associated with a plurality of buckets (e.g., buckets that are the same as, or similar to, buckets 430, 432 of FIG. 4). For example, the first event may be associated with a simulated phishing failure bucket, an elicitation attack failure bucket, a phishing clicked bucket, an actual phish delivered bucket, a malicious entity in email bucket, a risky email activity bucket, a failed pop quiz bucket, a training expiry bucket, a phish alert button (PAB) bucket, a training completion bucket, and/or a real-time coaching bucket. It will be understood that various implementations may include aggregator buckets having more buckets, fewer buckets, and/or different buckets.

The simulated phishing failure bucket may be associated with one or more simulated phishing events involving users and associated devices that are targeted by the simulated phishing events; the elicitation attack failure bucket may be associated with a determination of whether one or more simulated phishing events were successful (users took appropriate action and provided input to the corresponding devices to address the simulated phishing event) or were not successful (e.g., users did not take appropriate action and provided input to the corresponding devices to address the simulated phishing event); the phishing clicked bucket may be associated with users providing input to associated devices to select phishing content displayed on the associated devices; an actual phish delivered bucket may be associated with a determination of whether the user or associated device interacted with the content delivered to the user or corresponding device or otherwise caused data associated with the event to be received by (e.g., downloaded by) the associated device; a malicious entity in email bucket may be associated with one or more email addresses included in an email (sent or received by the user and associated devices) where the one or more email addresses are associated with a device of a known individual or group involved in one or more previous phishing attacks, a risky email activity bucket may be associated with one or more actions taken by users and associated devices in response to receiving an email associated with a phishing attack, a failed pop quiz bucket may be associated with a determination of whether users and associated devices provide input in response to a message, the input indicating the users identified a phishing attack or attempt, a training expiry bucket associated with a period of time starting when users and associated devices engage in a training (e.g., a training on how to identify phishing attacks), a phish alert button (PAB) bucket associated with an indication of whether input was provided by users and associated devices to alert a system administrator of a potential phishing attack, a training completion bucket indicating whether users and associated devices were involved and completed training associated with identification of phishing attacks, and/or a real-time coaching bucket indicating whether users and associated devices were involved in real-time coaching with a system administrator to identify features of a phishing attack.

In some embodiments, the second event may be associated with an aggregator bucket (e.g., an aggregator bucket that is the same as, or similar to, the aggregator buckets 420 of FIG. 4) corresponding to events (e.g., events that are the same as, or similar to, one or more of events 412 of FIG. 4) involving password hygiene (e.g., practices that can be implemented by users and corresponding devices to manage and protect passwords over the password lifecycle). The second event may be associated with a plurality of buckets (e.g., buckets that are the same as, or similar to, buckets 430, 432 of FIG. 4). For example, the second event may be associated with a high severity vulnerability, a training expiry bucket, a medium severity vulnerability bucket, a failed pop quiz bucket, and a training completion bucket. It will be understood that various implementations may include more buckets, fewer buckets, and/or different buckets.

The high severity vulnerability bucket may be associated with whether the user and corresponding devices has taken one or more actions associated with a probability of compromising a password associated with the user and corresponding devices; the training expiry bucket may be the same as, or similar to, the training expiry bucket discussed above; the medium severity vulnerability bucket may be associated with whether the user and corresponding devices has taken one or more second actions associated with a second probability of compromising a password associated with the user and corresponding devices, the second probability being less than the probability associated with the high severity vulnerability bucket; the failed pop quiz bucket may be the same as, or similar to, the failed pop quiz bucket discussed above; and the training completion bucket may be the same as, or similar to, the training completion bucket discussed above.

In some embodiments, the one or more buckets associated with the first event and the second event may be associated with a number of look back days as described herein. As illustrated, each bucket is associated with sixty look back days. It will be understood that more look back days or fewer look back days may be associated with each bucket. In some embodiments, the one or more buckets may be associated with a safest count.

In some embodiments, the one or more buckets associated with the first event and the second event may be associated with a safest count. The safest count may be associated with a total number of activities involving the user and the corresponding device that involve improving future interactions of the users and corresponding devices. Activities associated with the safest count can include, for example, users providing input to corresponding devices during training sessions indicating the users understand certain cybersecurity best practices and/or the like. In some embodiments, the one or more buckets associated with the first event and the second event may be associated with a riskiest count as described herein. In examples, the riskiest count may be associated with activities involving the user and the corresponding device that are associated with activities involved unsafe interactions of the users and corresponding devices. Activities associated with the riskiest count can include, for example, users providing input to corresponding devices during training sessions indicating the users do not understand certain cybersecurity best practices and/or the like.

In some embodiments, the one or more buckets associated with the first event and the second event may be associated with a bucket risk level. The bucket risk level may be associated with a value indicating a relative importance of the events associated with a given bucket corresponding to an aggregator bucket. In some embodiments, the value may be a value between 1 and 10, with 1 being a lower risk relative to other risks, and 10 being a higher risk relative to other risks. In some embodiments, In some embodiments, the one or more buckets associated with the first event and the second event may be associated with a mitigation percentage. The mitigation percentage may be an percentage by which a combined risk represented by all of the buckets of an aggregator bucket can be reduced. For example, where a user engages with a corresponding device to communicate with a system administrator about an event that involved the user and the corresponding device, the overall risk associated with the event may be reduced by the mitigation percentage. In some embodiments, the one or more aggregator buckets are associated with an aggregator bucket risk score. The aggregator bucket risk score may be the same as, or similar to, one or more of the risk scores discussed with respect to FIG. 4. For example, one or more events corresponding to one or more aggregator buckets may be associated with an aggregator bucket risk score, where the aggregator bucket risk score represents an overall risk that the user and associated device will be involved in a future event. In some embodiments, the aggregator bucket risk score may be determined based on one or more of the above-described aspects of the buckets corresponding to respective aggregator buckets. As illustrated, the first event is associated with an aggregator bucket risk score of 10 out of 10; and the second event is associated with an aggregator bucket risk score of 3 out of 10.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMS, RAMS, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

No aspect, component, element, structure, act, step, function, instruction, and/or the like used herein should be construed as critical or essential unless explicitly described as such. In addition, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open ended terms. Further, the phrase “based on” is intended to mean “based at least partially on” unless explicitly stated otherwise.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

What is claimed is:

1. A method for generating a risk score of a user based at least on groups of events related to security, the method comprising:
receiving, by one or more servers, data associated with a plurality of events over time, the plurality of events representing one or more security risks associated with one or more users to an organization;
identifying, by the one or more servers, a plurality of buckets for which to assign the plurality of events, each bucket identifying a collection of events that are assigned a level of risk from a plurality of levels of risk, each level of risk assigned a weight;
assigning, by the one or more servers, each event of the plurality of events to a bucket of the plurality of buckets based at least on a type associated with each event;
computing, by the one or more servers, a risk score for a user of the one or more users based at least on a function of the weight assigned to each bucket and a quantity of events in each bucket; and
providing, by the one or more servers, a graphical user interface configured to display the risk score and information identifying reasons computation of the risk score changes over time for the user.

2. The method of claim 1, wherein the graphical user interface is further configured to display one or more recommendations for mitigations based on risk factors identified while generating the risk score.

3. The method of claim 1, further comprising determining, by the one or more servers, an action to take based at least on the risk score.

4. The method of claim 3, further comprising taking, by the one or more servers, the action of providing electronic training to the user corresponding to the risk score of the user or the action of initiating a simulated phishing campaign targeted to the user based at least on the risk score.

5. The method of claim 1, wherein each event comprises a type of a risky event, a secure event or a mitigation event.

6. The method of claim 1, further comprising assigning, by the one or more servers, each of the plurality of buckets to an aggregator bucket of a plurality of aggregator buckets; each aggregator bucket of the plurality of aggregator buckets comprising a collection of one or more buckets representing related elements of security risk.

7. The method of claim 6, wherein each aggregator bucket of the plurality of aggregator buckets is assigned second weight according to a second level of risk assigned to each aggregator bucket.

8. The method of claim 6, further comprising generating, by the one or more servers, the risk score for the user based on the function of the second weight assigned to each aggregator bucket.

9. The method of claim 1, further comprising removing, by the one or more servers, an event of the plurality events from a bucket based on meeting a threshold of a number of look back days.

10. The method of claim 1, further comprising modifying, by the one or more servers, the risk score based at least on one of a booster factor or an offset of the user or the organization.

11. A system for generating a risk score of a user based at least on groups of events related to security, the system comprising:
one or more servers comprising one or more processors, coupled to memory and configured to:
receive a plurality of events over time related to security risk of one or more users to an organization;
identify, by a model, a plurality of buckets for which to assign the plurality of events, each bucket identifying a collection of events that are assigned a level of risk from a plurality of levels of risk, each level of risk assigned a weight;
assign, by the model, each event of the plurality of events into a bucket of the plurality of buckets based at least on a type of each event;
compute, by the model, a risk score for a user of the one or more users based at least on a function of the weight assigned to each bucket and a quantity of events in each bucket; and
cause a display of a graphical user interface configured to display the risk score and information identifying reasons computation of the risk score changes over time for the user.

12. The system of claim 11, wherein the graphical user interface is further configured to display one or more recommendations for mitigations based on risk factors identified while generating the risk score.

13. The system of claim 11 wherein the one or more servers are further configured to determine an action to take based at least on the risk score.

14. The system of claim 13, wherein the one or more servers are further configured to take the action of providing electronic training to the user corresponding to the risk score of the user or the action of initiating a simulated phishing campaign targeted to the user based at least on the risk score.

15. The system of claim 11, wherein each event comprises a type of a risky event, a secure event or a mitigation event.

16. The system of claim 11, wherein the model is further configured to assign each of the plurality of buckets to an aggregator bucket of a plurality of aggregator buckets; each aggregator bucket of the plurality of aggregator buckets comprising a collection of one or more buckets representing related elements of security risk.

17. The system of claim 16, wherein each aggregator bucket of the plurality of aggregator buckets is assigned second weight according to a second level of risk assigned to each aggregator bucket.

18. The system of claim 16, wherein the model is further configured to compute the risk score for the user based on the function of the second weight assigned to each aggregator bucket.

19. The system of claim 11, wherein the one or more servers are further configured to remove an event of the plurality events from a bucket based on meeting a threshold of a number of look back days.

20. The system of claim 11, wherein the model is further configured to modify the risk score based at least on one of a booster factor or an offset of the user or the organization.
